(19) United States
(12) Patent Application Publication
(10) Pub. No.: US 2023/0232811 A1
(43) Pub. Date: Jul. 27, 2023

(54) MICROWAVES FOR PLANT AND PEST CONTROL

(71) Applicant: ARIEL SCIENTIFIC INNOVATIONS LTD., Ariel (IL)

(72) Inventor: Moshe EINAT, Ariel (IL)

(21) Appl. No.: 18/101,484

(22) Filed: Jan. 25, 2023

Related U.S. Application Data
(63) Continuation of application No. PCT/IB2021/056690, filed on Jul. 25, 2021.
(60) Provisional application No. 63/056,656, filed on Jul. 26, 2020.

(51) Int. Cl. A01M 1/22

(52) U.S. Cl. CPC A01M 1/226

(57) ABSTRACT

Disclosed are methods and devices that are useful for limiting plant growth using microwaves without the use of chemical agents such as herbicides and, in some embodiments, are thereby useful for weed control. Disclosed are also methods and devices that are useful for injuring and/or killing arthropods using microwaves without the use of chemical agents such as pesticides and, in some embodiments, are thereby useful for the control of arthropod infestation.

### RELATED APPLICATION

The present application gains priority from U.S. Provisional Patent Application 63/056,656 filed 26 Jul. 2020 which is included by reference as if fully set-forth herein.

### FIELD AND BACKGROUND OF THE INVENTION

The invention, in some embodiments, relates to the field of microwaves. More particularly, but not exclusively, in some embodiments the invention relates to methods and devices that are useful for limiting plant growth with the use of microwaves that are thereby useful, for example, for weed control. Additionally, in some embodiments the invention relates to methods and devices that are useful for injuring and/or killing arthropods with the use of microwaves and that are thereby useful, for example, for the control of arthropod infestation.

Arthropod infestation of fibrous items such as carpets, curtains and bedding or on floors is a known problem, especially in lodgings with substantial turnover such as hotels, motels, hostels and settings such as barracks and sea vessels. Infestation by arthropods such as insects and arachnids (causes extreme discomfort, can lead to disease and substantial financial damage for institutions such as hotels. Eliminating such infestation is costly, difficult and typically involves using chemical pesticides which people generally prefer not to contact and typically requires that the treated item be out of use for an extended period of time to allow pesticide residue to dissipate from the item.

It is often necessary to kill plants, for example, unwanted plants that grow near a place (e.g., a building) or unwanted plants such as weeds that interfere with the growth of desired plants such as crop plants. Typically, unwanted plants are killed with herbicides. Herbicides are cheap and can be easily applied to treat large areas. However, herbicides are pollutants, can contaminate water sources, their use raises health concerns for the people applying the herbicides, for people in the vicinity of the area applied and for people who consume crop products contaminated with residual herbicide, herbicides can kill beneficial animals such as bees, and unwanted plants can develop resistance to a given herbicide.

The agricultural use of microwaves for control of plants has been reported, see for example: U.S. Pat. Nos. 4,092,800; 6,401,637; German patent DE10037078; Chinese utility model CN2607780Y; and:

[1] Mattsson B in “Weed control by microwaves—a review” (OT: Mikrovagor for ugrasbekampning—en litteraturstudie) by the Department of Agricultural Eng. Swedish University of Agricultural Sciences, Alnarp, Sweden. Report 171, 1993;
[2] Nelson S in “A review and assessment of microwave energy for soil treatment to control pests” Transactions of the ASAE 1996, 39(1), 281-289;
[3] Velazquez-Marti B, Gracia-Lopez C, Marzal-Domenech A in “Germination inhibition of undesirable seed in the soil using microwave radiation,” Biosystems Engineering 2006, 93(4), 365-373;
[4] Velazquez-Marti B, Gracia-Lopez C, de la Puerta R in “Work conditions for microwave applicators designed to eliminate undesired vegetation in a field,” Biosystems Engineering 2008, 100(1), 31-37;

### [5] Mavrogianopoulos GN, FrangoudakisA, Pandelakis J in “Energy Effcient Soil Disinfestation by Microwaves,” Journal of Agricultural Engineering Research 2000, 75(2), 149-153, 2000;

[6] Sartorato I, Zanin G, Baldoin C, de Zanche C in “Observations on the potential of microwaves for weed control,” Weed Research 2006, 46(1), 1-9; and

### [7] Brodie G, Khan JK, Gupta D, Folette S, Bootes N in “Microwave Weed and Soil Treatment in Agricultural Systems” AMPERE Newsletter 2017, 93, 9-17.

It would be useful to have methods and/or devices that are useful for reducing the intensity of an arthropod infestation and do not require the use of pesticides.

It would be useful to have methods and/or devices that are useful for limiting plant growth and that can be used, inter alia, for weed control and do not require the use of herbicides.

### SUMMARY OF THE INVENTION

The invention, in some embodiments, relates to the field of microwaves and more particularly, but not exclusively, to methods and devices that are useful for limiting plant growth (and are thereby useful for example, for weed control) and/or for control of arthropod infestations.

According to an aspect of some embodiments of the teachings herein, there is provided a method for limiting the growth of plants, comprising:

providing a microwave generator with at least one functionally-associated antenna; and
irradiating a plant with microwave radiation from the at least one antenna generated by the microwave generator, the microwave radiation having an intensity for a duration to heat the meristem of the plant to a temperature sufficient to kill or stunt the growth of the plant.
   In some embodiments, the plants are in an agricultural field. In some embodiments, the plants are in a built-up area and/or hardened surface.

According to an aspect of some embodiments of the teachings herein, there is also provided a method for reducing the intensity of an arthropod infestation, comprising:

providing a microwave generator with at least one functionally-associated antenna; and
irradiating an item potentially infested with arthropods with microwave radiation from the at least one antenna generated by the microwave generator, the microwave radiation having an intensity for a duration to heat arthropods to a temperature sufficient to kill at least some arthropods infesting the item.
   As used herein. “reducing the intensity of an arthropod infestation” includes a prophylactic use. In some embodiments, the item is in a lodging. In some embodiments, the the item is selected from the group consisting of a fibrous product and a floor.

According to an aspect of some embodiments of the teachings herein, there is also provided a device suitable for irradiation of plants and/or for irradiation of items potentially-infested with arthropods with microwaves, the device comprising:
a. a microwave generator for generating microwaves having a specified frequency;
b. a slotted microwave waveguide, being a straight hollow conductor with a longitudinal axis, a vertical axis and a transverse axis physically associated with the microwave generator so that an aperture of the microwave generator introduces microwaves generated by the microwave generator into an inner volume of the waveguide, the waveguide including one or more slot antennas configured to radiate microwaves having the specified frequency generated by the microwave generator from the inner volume of the waveguide to outside the slotted waveguide all in the direction within 200 parallel to the vertical axis of the slotted waveguide; and
c. a supporting structure for maintaining the slotted microwave waveguide in a position suitable for irradiating plants and/or for irradiating items potentially infested with arthropods during use of the device,
   wherein the one or more slot antennas are within 20° of parallel to the longitudinal axis and outside the plane defined by the vertical axis and the longitudinal axis of the waveguide.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

### In the Figures:

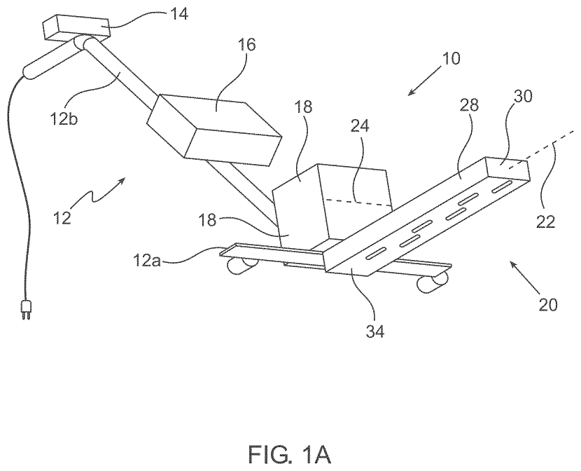

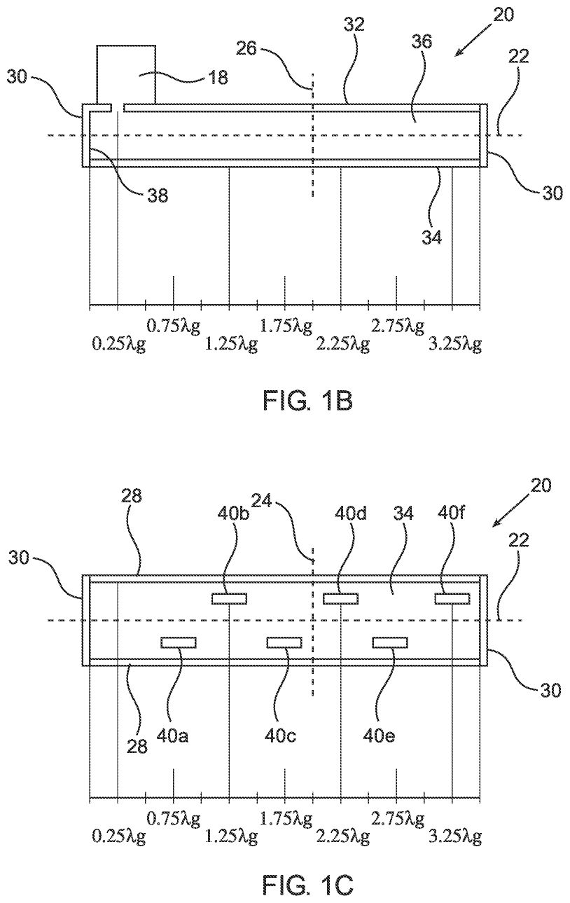

FIGS. 1A, 1B and 1C schematically depict an embodiment of a device according to the teachings herein in perspective from the bottom (FIG. 1A), side cross section (FIG. 1B) and from the bottom (FIG. 1C);

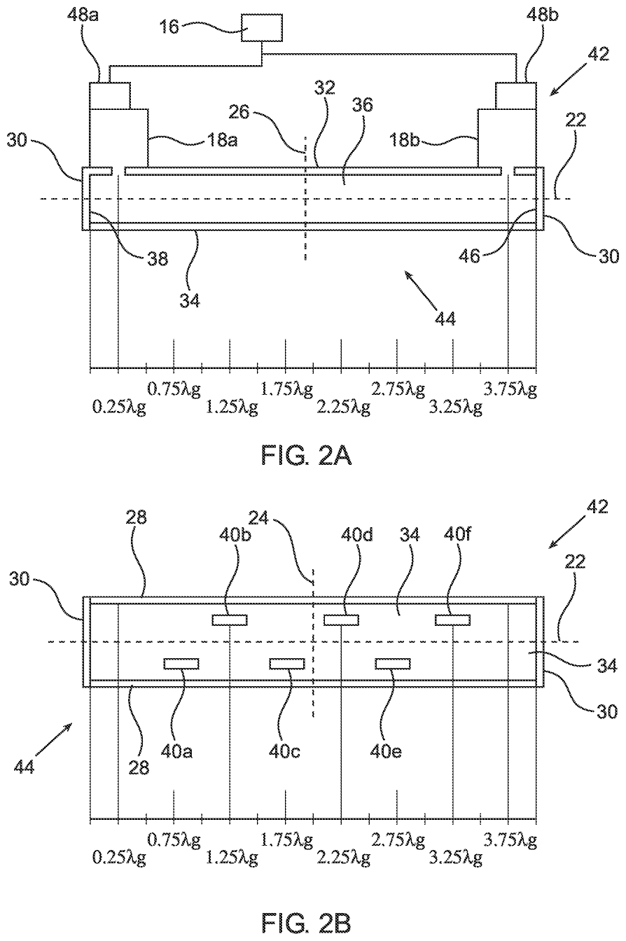

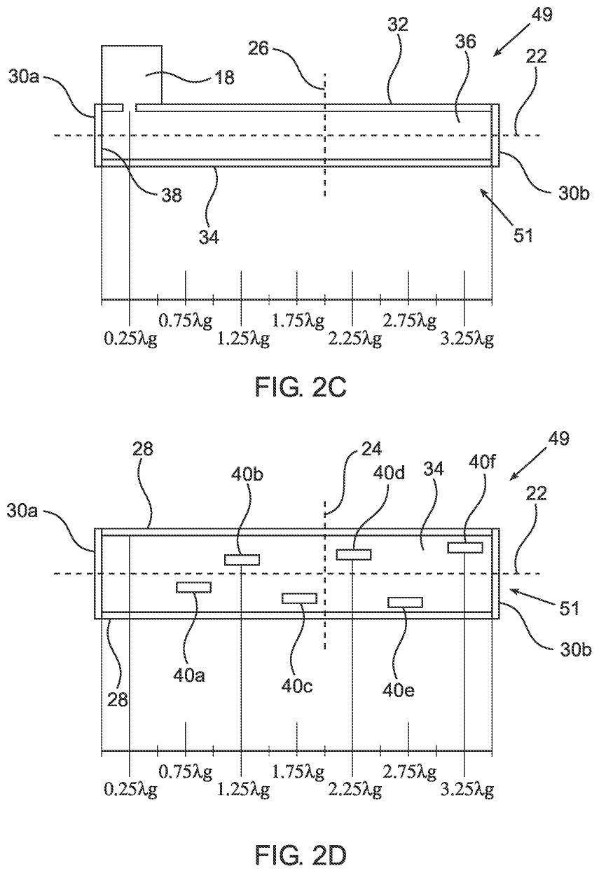

FIGS. 2A and 2B schematically depict an embodiment of a device according to the teachings herein having two microwave generators in side cross section (FIG. 2A) and from the bottom (FIG. 2B):

FIGS. 2C and 2D schematically depict an embodiment of a device according to the teachings herein comprising a non-resonant waveguide in side cross section (FIG. 2C) and from the bottom (FIG. 2D);

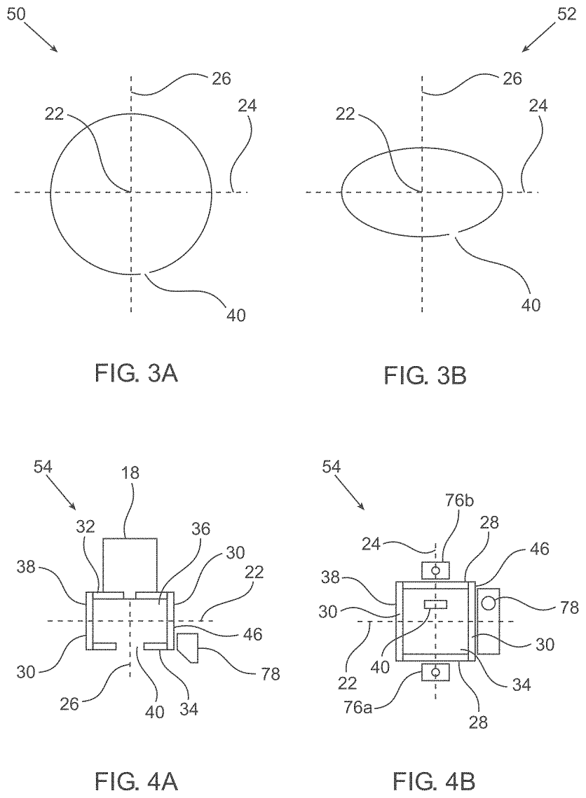

FIGS. 3A and 3B schematically depict embodiments of slotted waveguides according to the teachings herein in side cross section, a slotted waveguide with circular cross section (FIG. 3A) and with oval cross section (FIG. 3B);

FIGS. 4A and 4B schematically depict an embodiment of a device according to the teachings herein having a single slot antenna in side cross section (FIG. 4A) and from the bottom (FIG. 4B);

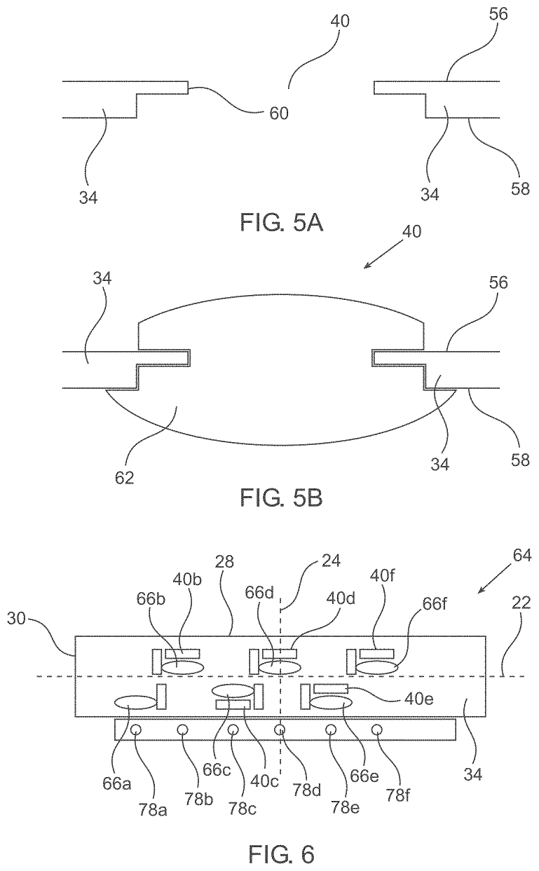

FIGS. 5A and 5B schematically depict an inset slot antenna according to an embodiment of the teachings herein in side cross section, without a cover (FIG. 5A) and with a cover (FIG. 5B);

FIG. 6 schematically depicts an embodiment of a slotted waveguide according to the teachings herein having slot shutters viewed from the bottom;

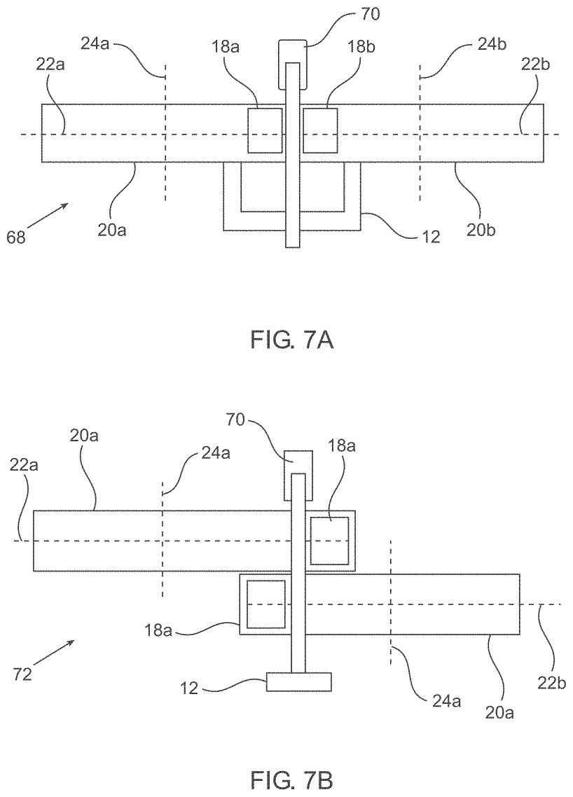

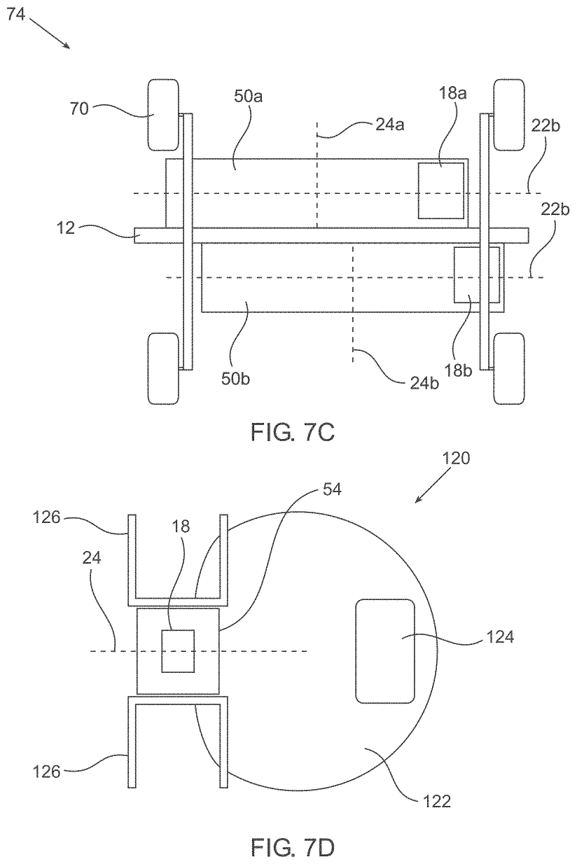

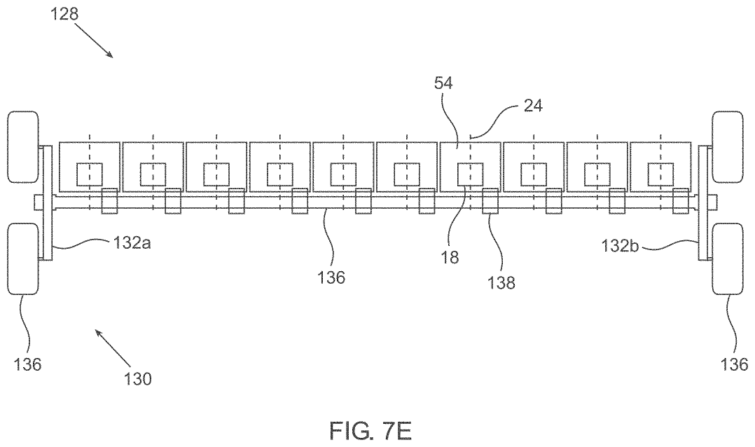

FIGS. 7A, 7B and 7C each schematically depicts a different embodiment of a device according to the teachings herein having more than one slotted waveguide viewed from above;

FIG. 7D schematically depicts an embodiment of a device according to the teachings herein having a supporting structure that is a household robot:

FIG. 7E schematically depicts an embodiment of a device according to the teachings herein, the device configured for treating an item such as a bed;

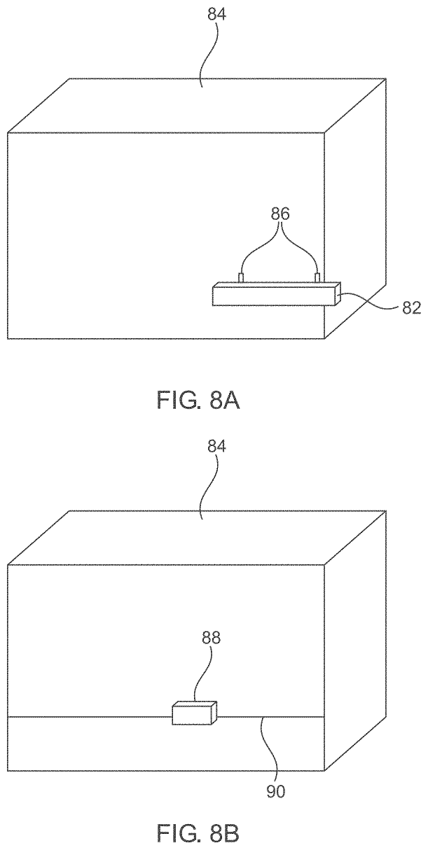

FIGS. 8A and 8B each schematically depicts a different embodiment of a device according to the teachings herein having an immovable supporting structure securing the device to a building;

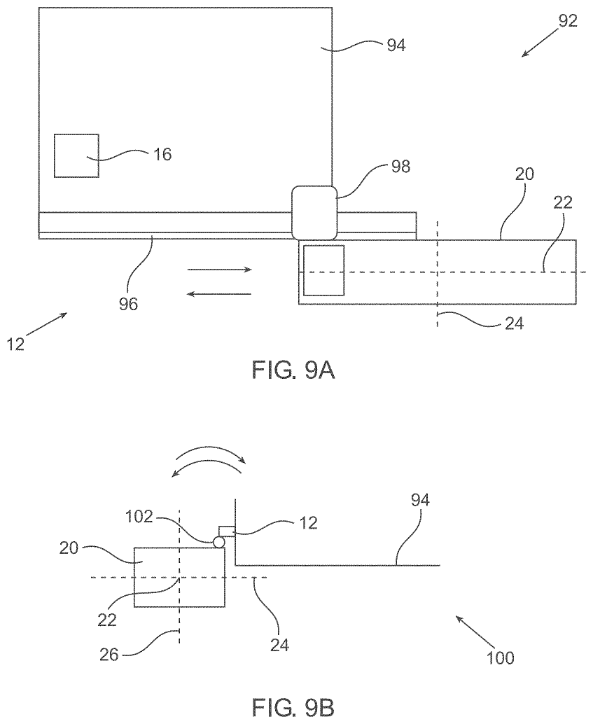

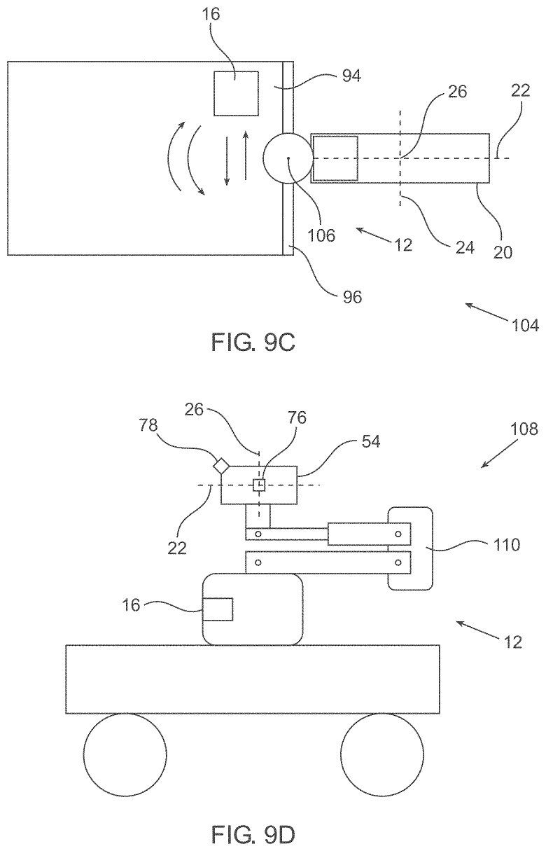

FIGS. 9A, 9B, 9C and 9D each schematically depicts a different embodiment of a device according to the teachings herein having a supporting structure configured to allow moveable mounting of the waveguide to a vehicle: translation of the waveguide parallel to the longitudinal axis (FIG. 9A), rotation around an axis parallel to the longitudinal axis (FIG. 9B), motion in a plane parallel to the ground (FIG. 9C) and a supporting structure that includes a robotic arm (FIG. 9D):

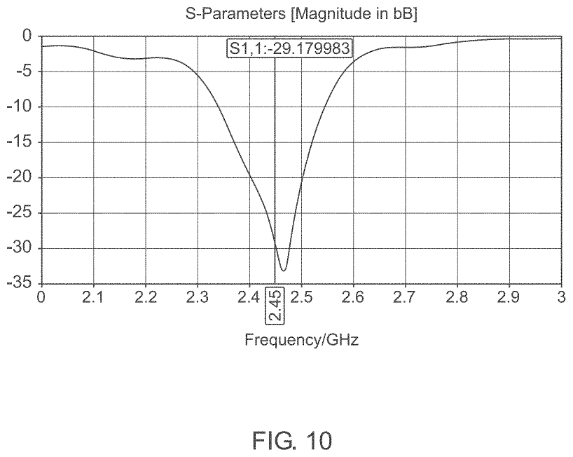

FIG. 10 shows the Si 1 of a single slot antenna of a device of FIG. 1:

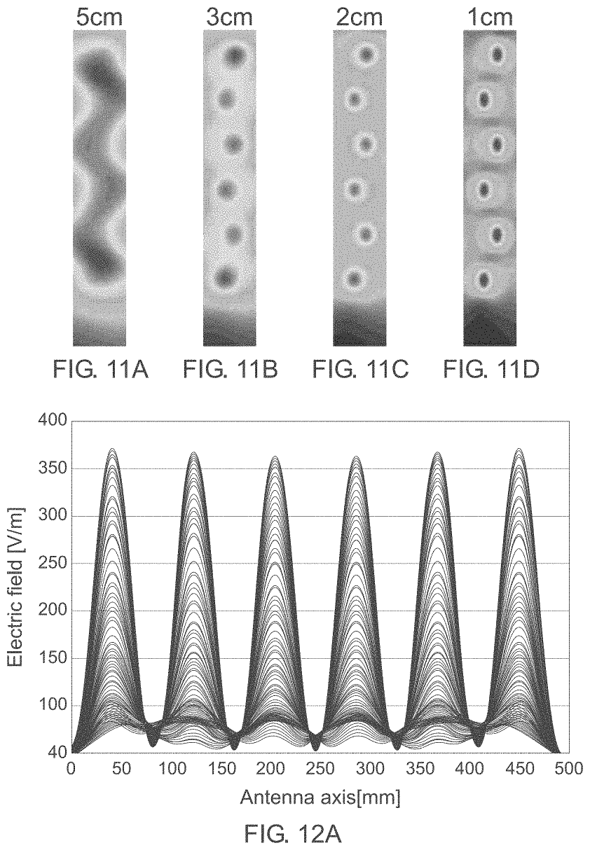

FIGS. 11A-11D show the normalized near-field patterns of the antennas of the device of FIG. 1 in a plane parallel to a bottom side of the device at an offset distance of 5 cm (FIG. 11A), 3 cm (FIG. 11B), 2 cm (FIG. 11C) and 1 cm (FIG. 11D);

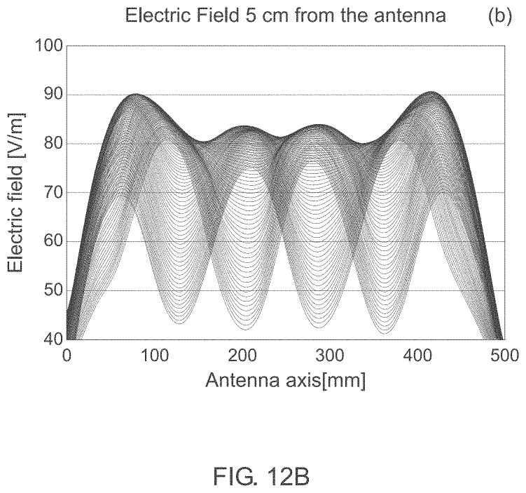

FIGS. 12A and 12B show the absolute values of the intensity of the electric field in a plane parallel to the bottom side of the slotted waveguide of the device of FIG. 1 at an offset distance of 5 cm (FIG. 12A) and 1 cm (FIG. 12B) along the longitudinal axis:

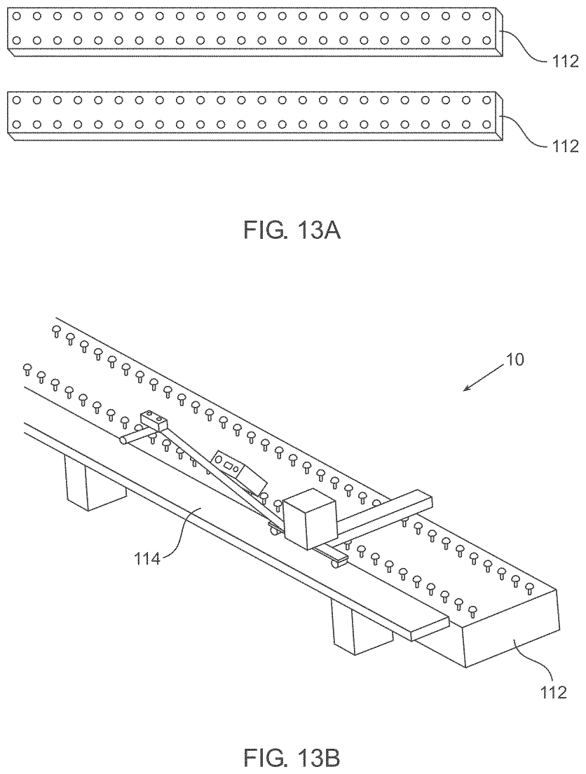

FIGS. 13A and 13B schematically depict the experiment used to test the efficacy of the device of FIG. 1 in controlling plant growth: FIG. 13A depicting two troughs of plants and FIG. 13B depicting how the device was positioned to irradiate plants in a trough:

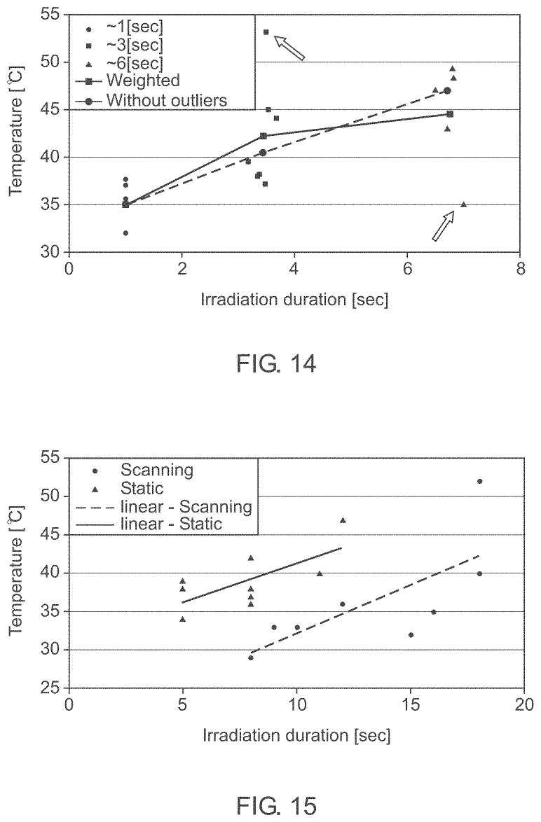

FIG. 14 is a graph showing results of irradiation of 2-leaf plants;

FIG. 15 is a graph showing results of irradiation of 4-leaf plants; and

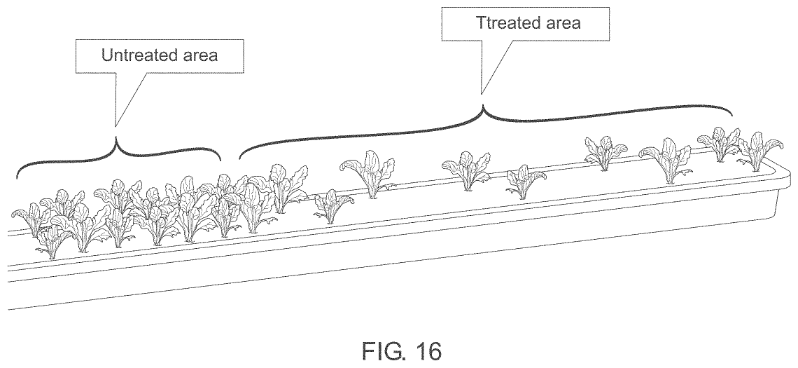

FIG. 16 is a reproduction of a photograph showing the long-term damage caused to irradiated plants.

### DESCRIPTION OF SOME EMBODIMENTS OF THE INVENTION

The invention, in some embodiments, relates to the field of microwaves and more particularly, but not exclusively, to methods and devices that are useful for limiting plant growth (and are thereby useful for example, for weed control) and/or for control of arthropod infestations.

The principles, uses and implementations of the teachings of the invention may be better understood with reference to the accompanying description and figures. Upon perusal of the description and figures present herein, one skilled in the art is able to implement the teachings of the invention without undue effort or experimentation. In the figures, like reference numerals refer to like parts throughout.

Before explaining at least one embodiment of the invention in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purpose and should not be regarded as limiting.

As discussed in the introduction, there is often a need to limit plant growth, even to the extent of killing the plant, preferably with reduced or no use of herbicides. Known methods and devices for limiting plant growth by irradiation of the plants and/or soil with microwaves have various disadvantages, for example are slow or require large amounts of energy. Herein, the Inventors disclose that plant growth can be controlled by using microwaves to heat the meristem of a plant to a degree that is sufficient to stunt the growth of a plant and even kill the plant. The Inventors also disclose a device that is particularly useful for heating the meristem of a plant.

Also as discussed in the introduction, there is often a need to control arthropod infestations, preferably with reduced or no use of pesticides. Herein, the Inventors disclose that an arthropod infestation can be controlled by using microwaves to heat arthropods in an item potentially infested with the arthropods to a temperature that is sufficient to kill at least some of the arthropods infesting the item. Killing at least some of the arthropods reduces the intensity of the infestation The Inventors also disclose a device that is particularly useful for controlling arthropod infestations.

### Method for Limiting the Growth of Plants

According to an aspect of some embodiments of the teachings herein, there is provided a method for limiting the growth of plants, comprising:

providing a microwave generator with at least one functionally-associated antenna; and
irradiating a plant with microwave radiation from the at least one antenna generated by the microwave generator, the radiation having an intensity for a duration to heat the meristem of the plant to a degree sufficient to kill or stunt the growth of the plant.

In embodiments of the method, no effort is made to heat the soil or an entire plant as this requires depositing a substantial amount of energy (especially in cold and/or wet climates) which is expensive, slow, kills seeds and soil microorganism, leaving barren soil that can subsequently be invaded by pathogens. Instead, embodiments of the method endeavor to limit the growth of undesired plants and even kill undesired plants by heating only the plant itself and in preferred embodiments especially the meristem thereof. As is experimentally demonstrated herein, it is possible to heat the meristem of a plant, especially of a seedling, for a relatively short time using relatively low-intensity microwave radiation to achieve meristem temperatures that subsequently limit the growth of the plant and even lead to the death of the plant. By avoiding substantial heating of soil and unnecessarily heating of the plant, energy use is reduced, allowing relatively quick treatment using a relatively small and low-power microwave generator.

### Method for Reducing the Intensity of an Arthropod Infestation

According to an aspect of some embodiments of the teachings herein, there is also provided a method for reducing the intensity of an arthropod infestation, comprising:

providing a microwave generator with at least one functionally-associated antenna; and
irradiating an item potentially infested with arthropods with microwave radiation from the at least one antenna generated by the microwave generator, the microwave radiation having an intensity for a duration to heat arthropods (including one, some or all stages of arthropod development e.g., adults, nymphs and/or ova) to a temperature sufficient to kill at least some arthropods infesting the item.

By killing at least some of the arthropods infesting the item, the intensity of the arthropod infestation is reduced to an acceptable degree even if not all the arthropods are destroyed, thereby allowing delaying and even obviating the use of chemical pesticides. Since there is no poisonous residue that requires time to dissipate, the item can be used immediately after treatment according to the method of the teachings herein.

Infestation by any susceptible arthropod can be controlled using the teachings herein, for example insects (e.g., ants, bed bugs, fleas, cockroaches, carpet beetles, flies) and arachnids (e.g., mites, ticks).

In some embodiments, the item is in a lodging, e.g., hotel, motel, hostel, guest house and settings such as barracks and sea vessels (naval vessels, cruise ships). In some embodiments, the item is selected from the group consisting of a fibrous product (e.g., rug, carpet, curtain and bedding (including mattresses, sheets, quilts, duvets, bed skirts, bedspreads, bolsters, pillows, duvet covers, mattress pads, mattress protectors, neck rolls, sleeping bags and blankets) or a floor (e.g., wooden floorboards such as parquet, carpets, rugs). In some embodiments, the item is animal manure (e.g., chicken or cow manure) held in a vessel and the method is implemented to kill or damage arthropods insects such as flies which deposit eggs in the surface of the manure.

In some embodiments, the irradiated item is made of a material that does not substantially absorb microwaves so that the microwaves are primarily or exclusively absorbed by arthropods infesting the item. Some such embodiments are preferred as control of arthropods is quick, does not potential cause heat damage to the irradiated items, and allows the use of a relatively small and low-power microwave generator.

In some embodiments, the irradiated item is made of a material that absorbs substantial microwaves so that the microwaves are absorbed both by by arthropods infesting the item and the item itself. Some such embodiments are preferred as the elevated heat of the item caused by absorption of the microwaves assists in killing at least some of the arthropods. Some such embodiments are less preferred as these require prolonged irradiation duration to ensure that a sufficiently-high temperature is achieved to achieve the desired effect and/or the heating can cause damage of the item (e.g., discoloration, reduced lifetime) and/or there is a danger of ignition of the item due to the irradiation.

Whether or not the irradiated item absorbs substantial microwaves, it is preferred that a contiguous region of the item be irradiated at any one time as detailed hereinbelow. When a contiguous region is irradiated at any one time in accordance to the teachings herein, there are no cold spots (where an arthropod can escape to) and no hot spots (where overheating can damage an item).

### General Features of the Methods

The microwave generator for implementing the methods according to the teachings herein is any suitable microwave generator, e.g., a magnetron such as a cavity magnetron.

Any suitable microwave frequency can be used, in some embodiments a frequency selected from the group consisting of 915 MHz and 2.45 GHz.

In some embodiments it is desirable that the microwave generator be relatively small, light, cheap and/or have a low power input for operation. Accordingly, in some embodiments, the microwave generator requires not more than 10 kW power for operation, not more than 8 kW, not more than 6 kW, not more than 4 kW, not more than 2.2 kW and even not more than 1.6 kW, not more than 1.2 kW, not more than 1.0 kW and even not more than 0.8 kW. In the Experimental Section an embodiments of the method herein is demonstrated using a cavity magnetron requiring 1.1 kW input power for operation used in a standard microwave oven.

The at least one antenna is any suitable antenna that is (or antennas that are) functionally-associated with microwave generator and radiates generated microwaves in a desired direction as microwave radiation. In some preferred embodiments, the antenna is a slot antenna of a slotted microwave waveguide. In some such embodiments, the microwave generator is directly physically associated with the slotted microwave waveguide so that the device comprising the microwave generator and the slotted microwave waveguide is devoid of any intervening microwave waveguide or microwave transmission line to guide microwaves from the microwave generator to the slotted microwave waveguide. In some embodiments, the device comprising the microwave generator and the slotted microwave waveguide is devoid of a tuner. In some embodiments, the device comprising the microwave generator and the slotted microwave waveguide is devoid of a modulator for encoding information in the generated microwaves. In some embodiments, the slotted microwave waveguide is a resonant waveguide so that during operation of the microwave generator, a standing wave is formed inside the waveguide. In some alternate embodiments, the slotted microwave waveguide is a non-resonant waveguide so that during operation of the microwave generator, no standing wave is formed inside the waveguide. A person having ordinary skill in the art of microwave transmission is able to implement all such embodiments, such as a resonant or non-resonant slotted waveguide without undue experimental effort upon perusal of the description and figures.

In some preferred embodiments, during the irradiation of a plant, the at least one antenna is positioned to maintain the meristem of the plant is in the near-field region of the antenna, i.e., not more than about one wavelength (freespace wavelength, λ_{f})) from the antenna, e.g., about 32.8 cm for 915 MHz microwaves and about 12.2 cm for 2.45 GHz microwaves.

In some preferred embodiments, during the irradiation of an item potentially infested with arthropods, the at least one antenna is positioned to maintain a surface of the item in the near-field region of the antenna, i.e., not more than about one wavelength (f) from the antenna, e.g., about 32.8 cm for 915 MHz microwaves and about 12.2 cm for 2.45 GHz microwaves.

As noted above, the irradiation with microwaves is of an intensity and for a duration sufficient to heat the meristem of the plant to a temperature sufficient to kill or stunt the growth of the plant or is of an intensity and for a duration sufficient to heat arthropods to a temperature sufficient to kill at least some arthropods infesting the item. In some embodiments, the temperature is not less than 40° C., not less than 41° C. and even not less than 42° C. In some embodiments, the temperature is not more than 55° C. In some embodiments, the bulk of the plant is not heated by the microwaves to 40° C. that is to say, more than 70% of the above-ground mass of the plant is not heated to 40° C. and less than 30% of the above-ground mass of the plant (including a meristem) is heated to not less than 40° C., not less than 41° C. and even not less than 42° C.

In preferred embodiments, substantial energy is not wasted on heating the surroundings of the plant or the potentially infested item. Accordingly, in some embodiments, the irradiation is such that the substrate (e.g., soil) in which the plant is growing or the item potentially infested with arthropods is heated by less than 3° C., less than 2° C., less than 1° C. and even not heated at all.

The duration of irradiation of a specific plant or a specific part of the item is any suitable duration but is preferably as short as possible. In some embodiments the duration of irradiation of a given plant or part of an item is not more than 30 seconds and not less 0.5 seconds. In some embodiments the duration of irradiation of a given plant or part of an item is not more than 30 seconds, not more than 20 seconds, not more than 10 seconds, not more than 6 seconds and even not more than 3 seconds. Typically the irradiation duration is for not less than 0.5 second and even not less than 1 second. In some embodiments the duration of irradiation of a given plant or part of an item is not more than 30 seconds and not less 0.5 seconds. In some preferred embodiments the duration of irradiation of a given plant or part of an item is not more than 3 seconds and not less 1 second.

The density of energy of the irradiation is any suitable density, in some embodiments not less than 1 J/cm², in some embodiments not more than 30 J/cm², and in some embodiments not less than 1 J/cm² and not more than 30 J/cm².

The method for limiting growth of plants is preferably applied to young plants. As described in the experimental section, it has been found that the growth of young plants can be limited and the plants even killed with relatively modest irradiation intensities for relatively short irradiation durations. Accordingly, in some embodiments the plant that is being irradiated has fewer than 10 leaves, fewer than 8 leaves and even fewer than 6 leaves. In some embodiments, a plant that is being irradiated is a seedling having only 1 or 2 cotyledons.

The method according to the teachings herein may be applied in any desired location.

In some embodiments, the plants are in an agricultural field, e.g., are weeds that potentially interfere with crop plants. In some such embodiments, the method is applied to kill weeds prior to emergence of a crop plant (before or after sowing of the crop plant). In some embodiments, the method is applied around trees or between crop plants, e.g., to eliminate weeds. In some embodiments, the method of applied between rows of crop plants (furrows), e.g., to eliminate weeds.

In some embodiments, the plants are in a built-up area and/or growing in a hardened surface such as near, in and/or on buildings, parking lots, roads, streets, runways, statues, installations, railways, sidewalks and pavements. In some such embodiments, the method is employed to control or eliminate undesirable plant growth in, around and/or on the built-up area/hardened surface.

In some embodiments, the method is applied selectively, that is to say an undesirable plant is identified and only then irradiated. Accordingly, in some embodiments the method further comprises, prior to the irradiating identifying a specific undesirable plant; and positioning the at least one antenna so as to direct the microwave radiation generated by the microwave generator at the undesirable plant. Although in some embodiments the plant is identified by a person (e.g., visually), in some embodiments identification is done using an artificial detector such as a digital camera functionally associated with a computer to capture an image of a plant and to identify the plant as undesirable, the computer subsequently causing a mechanism such as robotic arm to position the at least one antenna so that plant can be irradiated as described above. In some such embodiments, the positioning is such that other plants that are at a distance of at least 5 cm from the undesirable plant are not substantially heated by the microwave radiation (e.g., heated by less than 3° C., less than 2° C. less than 1° C. and even not heated at all).

In some embodiments, the method is applied indiscriminately to eliminate or prevent substantial growth of plants from a surface or to reduce the intensity of an arthropod infestation. Accordingly, in some embodiments the method comprises irradiating a surface with microwaves to irradiate undesirable plants that are growing on the surface or to irradiate arthropods potentially infesting the item that bears the surface. In some embodiments, the surface includes older plants and younger plants, the irradiation sufficient to substantially damage the younger plants without substantially damaging the older plants. For example, a sown field of wheat can be treated in accordance with the teachings herein when the field reaches a Feekes Growth Stage 2.0 when tillers become visible. The wheat seedlings will be relatively resistant to brief microwave treatment, but emerging weeds with only cotyledons will be severely stunted or killed.

In some embodiments (for example, as described with reference to the device according to the teachings herein and in the experimental section) the at least one antenna is configured and positioned to produce an electric field, the electric field at the irradiated surface having a high-intensity contiguous region where all portions of the contiguous region have an intensity of 20% of the average intensity of the region. Such an electrical field is devoid of hot spots and cold spots that can reduce the efficacy of the device. In some embodiments, all portions of the contiguous region have an intensity of ±15% and even ±10% of the average intensity of the region. The size of the contiguous region is any suitable size. In some embodiments, the region is not less than 1 cm wide and not less than 5 cm long. In some such embodiments, the region is not less than 2 cm wide and even not less than 3 cm wide. In some such embodiments, the region is not less than 10 cm long, not less than 15 cm long, not less than 20 cm long, not less than 40 cm long and even not less than 60 cm long. When the device has a single antenna, such a contiguous region indicates that the electrical field of the antenna is relatively spatially homogeneous with no hot of cold spots. When the device has two or more antennas, such a contiguous region additionally indicates that the electrical fields of the antennas all have substantially the same intensity and that the electrical fields of two neighboring antennas sufficiently overlap to ensure that the region is contiguous. The average intensity of the electric field in the contiguous region is any suitable average intensity. In some embodiments, the average intensity in the contiguous region is not less than 40 V/m, not less than 50 V/m, not less than 60 V/m and even not less than 70 V/m. Typically, the average intensity is not greater than 120 V/m. In some such embodiments, during irradiation the electrical field is not moved. In some embodiments, the electrical field is moved (e.g., by moving the at least one antenna) to sweep the surface. In some embodiments the electrical field is moved by sweeping the at least one antenna back and forth over the surface. In some embodiments, the electrical field is moved by sweeping the at least one antenna in one direction thereby scanning the surface with the electrical field. In such embodiments, the rate at which the at least one antenna is moved is dependent on the width of the contiguous region (dimension parallel to the direction of motion) and the intensity of the electrical field to ensure that plants on the surface or the item are irradiated for a sufficient period of time. For example, in some embodiments, a typical contiguous region width of 5 cm and a required irradiation duration of 5-10 seconds, the antenna is moved at a rate of 1 cm/sec.

The methods according to the teachings herein may be implemented using any suitable device or suitable combination of devices. In some preferred embodiments, a method according to the teachings herein is implemented using an embodiment of the device according to the teachings herein.

### Device Suitable for Implementing the Methods of the Teachings Herein

A device according to the teachings herein is a device suitable for the irradiation of plants and/or for irradiation of items potentially-infested with arthropods with microwaves comprising a microwave generator and, as a microwave antenna, a slotted microwave waveguide. Slotted microwave waveguides are known in the art, see U.S. Pat. No. 2,573,746. As discussed below, the device is preferably devoid of a modulator. The device typically includes a supporting structure for maintaining the slotted microwave waveguide in a position to allow irradiation of plants with and/or for irradiating items potentially infested with arthropods with microwave radiation radiated by the slotted waveguide.

Thus, according to an aspect of some embodiments of the teachings herein, there is provided a device suitable for irradiation of plants and/or for irradiation of items potentially-infested with arthropods with microwaves, the device comprising:
a. a microwave generator for generating microwaves having a specified frequency;
b. a slotted microwave waveguide being a straight hollow conductor with a longitudinal axis, a vertical axis and a transverse axis physically associated with the microwave generator so that the aperture of the microwave generator introduces microwaves generated by the microwave generator into the inner volume of the waveguide, the waveguide including one or more slot antennas configured to radiate microwaves having the specified frequency generated by the microwave generator from the inner volume of the waveguide to outside the slotted waveguide in a direction within 200 parallel to the vertical axis the slotted waveguide; and
c. a supporting structure for maintaining the slotted microwave waveguide in a position suitable for irradiating plants and/or for irradiating items potentially infested with arthropods during use of the device.
   wherein the one or more slot antennas are oriented within 20° of parallel to the longitudinal axis and outside the plane defined by the vertical axis and the longitudinal axis of the waveguide.

The high directionality of the near-field of slotted microwave waveguides renders the device safe to use (the user and the surroundings are not irradiated), selective (in some embodiments allowing only a specific plant or a specific item to be irradiated) and efficient (much, most or all of the radiated energy is directed in a desired useful direction rather than lost).

### Resonant Slotted Microwave Waveguide

In some preferred embodiments, the slotted microwave waveguide is a resonant slotted microwave waveguide. In such preferred embodiments, the waveguide is dimensioned to function as a resonator for microwaves having the specified frequency thereby having a high Q-factor with little resonance damping. Compared to alternate antenna types, the slot antennas of a resonant slotted waveguide generate a stronger near-field for a given input energy. A person having ordinary skill in the art of microwave transmission is able to implement the teachings herein with a resonant waveguide without undue experimental effort upon perusal of the description and figures.

Typically, the inner volume of a resonant waveguide has two microwave-reflective longitudinal ends. In such embodiments, microwaves generated by the microwave generator enter the inner volume of the waveguide which is dimensioned to allow constructive interference between the microwaves reflected from the two ends and propagating in the distal to proximal direction and the microwaves propagating in the proximal to distal direction, forming a standing wave (or close to standing wave) in the inner volume. During operation, the device relatively reaches a steady state where the amount of energy added by the microwave generator equals the amount of energy radiated from the slot antennas.

In preferred such embodiments all of the slot antennas have the same dimensions and/or are positioned at the minimums/maximums of the standing wave and/or are equidistant from the longitudinal axis of the waveguide so that at steady state, the amount of energy radiated from each one of the slot antennas is identical.

A microwave generator generates microwaves having a specified frequency and corresponding freespace wavelength λ_{f}. However, inside the inner volume of the waveguide the guide wavelength of microwaves, λ_{g} is different and typically longer than λ_{f}. For a waveguide having a width a, λ_{g} is calculated using the formula.

λ_{g}=1/(1/λ_{f}²⁻1/2a²)\hat{ }0.5

The length of the inner volume of a resonant slotted waveguide is n*λ_{g}/2, n being an integer greater than 0.

### Non-Resonant Slotted Microwave Waveguide

In some alternate embodiments, the slotted microwave waveguide is a non-resonant slotted microwave waveguide so that during operation of the microwave generator, no standing wave is formed inside the waveguide: such a waveguide can be considered a transmission line where the wave advances but does not return. A person having ordinary skill in the art of microwave transmission is able to implement the teachings herein with a non-resonant waveguide without undue experimental effort upon perusal of the description and figures.

Like in a resonant waveguide, inside the inner volume of the waveguide the wavelength of the microwaves is λ_{g} as discussed above. However, since the waveguide is non-resonant, λ_{g} has no bearing on the length of the inner volume of the waveguide.

A non-resonant slotted waveguide typically has two longitudinal ends: a microwave-reflective proximal longitudinal end on the side closer to where the aperture of the microwave generator introduces microwaves into the microwave waveguide; and a microwave non-reflective distal longitudinal end. In some embodiments, the non-reflective longitudinal end of the waveguide is open. In some such embodiments, the non-reflective longitudinal end of the waveguide is covered to prevent entry of contamination into the volume of the waveguide. In some such embodiments, the non-reflective longitudinal end of the waveguide is covered with a microwave-absorbing material to ensure that there is no leakage of microwaves from the distal end of the waveguide during operation of the device.

In such embodiments, microwaves generated by the microwave generator enter the inner volume of the waveguide and propagate in a longitudinal direction from the aperture towards the non-reflective longitudinal end. When passing a slot antenna, some of the microwave energy leaks out therethrough so that the wave inside the waveguide loses energy as it propagates towards the non-reflective longitudinal end of the waveguide.

In preferred such embodiments, all of the slot antennas are positioned at the minimums/maximums of the wave and are at differing distances from the longitudinal axis of the waveguide, where slot antennas closer to the aperture (and the reflective end) are closer to the longitudinal axis than slot antennas further from the aperture (and thereby closer to the non-reflective end of the waveguide).

In such non-resonant embodiments, the slot antennas are preferably positioned and dimensioned so that substantially all of the microwave energy that is introduced into the inner volume of the waveguide by the microwave generator is radiated by the slot antennas and does not exit through the non-reflective end of the waveguide. A person having ordinary skill in the art is able to configure the size of the different slot antennas and the distance of the different slot antennas from the longitudinal axis so that the amount of energy exiting from the non-reflective end of the waveguide is less than 10%, less than 5%, less than 2% and even less than 1% of energy introduced into the inner volume of the waveguide by the microwave generator.

Further, it is preferable that the amount of energy radiated by all of the slot antennas be as close as possible to identical. A person having ordinary skill in the art is able to configure the size of the different slot antennas and the distance of the different slot antennas from the longitudinal axis so that the amount of energy radiated from each one of the slot antennas is within 90% of identical, i.e., the energy radiated from each one of the slot antennas is t 10% of the average energy radiated by the slot antennas.

In embodiments having more than one slot antenna, all of the slot antennas preferably have the same dimensions, but in some alternate embodiments the dimensions vary, e.g., slot antennas closer to the reflective end of the waveguide are smaller while slot antennas closer to the non-reflective end of the waveguide are larger (longer and/or wider).

### Embodiments of Both Resonant and Non-Resonant Waveguides

As the device is used specifically for heating plants and/or items and not for the transmission of information-bearing signals, in some embodiments the device is devoid of a modulator for encoding information in the microwaves generated by the microwave generator and radiated by the slot antennas.

In preferred embodiments, the microwave generator is directly physically associated with the slotted waveguide so that the aperture of the microwave generator introduces generated microwaves directly into the slotted waveguide inner volume. In some such embodiments, the aperture is at least partially located inside the inner volume of the slotted waveguide. In some such embodiments, the aperture is flush with an inner wall of the slotted waveguide. In the device according to the teachings herein, provision of a slotted microwave waveguide with a microwave generator directly physically-associated therewith allows a simple device for irradiating plants with microwaves, the device devoid of components such as a transmission line, waveguide or tuner for introducing microwaves generated by a microwave generator to a physically-separate antenna. Preferably, the microwave generator introduces generated microwaves into the inner volume at a location that corresponds to a minimum or maximum of the wave inside the inner volume, i.e., at m*0.25λ_{g}, m being an odd integer from a reflective end of the waveguide. In some embodiments, the microwave generator introduces generated microwaves at 0.25λ_{g} from a reflective end of the waveguide.

An embodiment of the device suitable for irradiation of plants with microwaves according to the teachings herein which was constructed and tested as discussed in the experimental section, device 10, is schematically depicted in FIG. 1A (perspective view from the bottom), FIG. 1B (side cross section) and FIG. 1C (view from the bottom). Device 10 includes a supporting structure 12 comprising a base 12a of steel plate with wheels and a handle 12b of 1″ aluminum pipes. A user interface 14, controller 16 and a cavity magnetron 18 with power supply including a transformer as a microwave generator from a standard commercially-available 1.1 kW microwave oven that generated 900 W of 2.45 GHz (λ_{f}=122 mm) microwaves were secured to base 12a and handle 12b. Electricity for powering magnetron 18 was provided using an extension cord plugged into a standard 220 V wall outlet.

A slotted microwave waveguide 20 was provided having an inner volume dimensioned to be resonant with 2.45 GHz microwaves having 4=164 mm. Waveguide 20 having a longitudinal axis 22, a lateral axis 24 and a vertical axis 26 was assembled from six 3 mm-thick aluminum panels: two side panels 28 were 48 mm high by 574 mm long; two end panels 30 were 48 mm high by 98 mm broad; and both a top panel 32 and a bottom panel 34 were 92 mm broad and 574 mm long. As a result, slotted waveguide 20 was a hollow rectangular cuboid having an inner volume 36 574 mm (3.5λ_{g}) long in the longitudinal direction, 92 mm (0.56λ_{g}) wide in the transverse direction and 42 mm (0.26λ_{g}) high in the vertical dimension. Being made of aluminum, both end panels 30 were microwave-reflective. Importantly, due to machining constraints the length of inner volume 36 was resonant with λ_{g}=164 mm but the width of inner volume 36 led to an actual λ_{g}=163 mm. This 0.6% difference likely led to some inefficiency but did not have a substantive effect on the working of device 10.

Centered on the longitudinal axis of and 41 mm (0.25λ_{g}) from the proximal end of top panel 32, a 30 mm diameter circular hole passed through top panel 32 to accept an aperture of magnetron 18 so that when magnetron 18 was activated, generated microwaves were directly introduced into inner volume 36 at a distance of 0.25λ_{g} from the proximal end of inner volume 36. In such a way, magnetron 18 introduced generated microwaves at a maximum of the standing wave formed inside waveguide 20.

Passing through bottom panel 34 were six 61 mm (0.37λ_{g}, 0.5λ_{f}) long (in the longitudinal direction) by 8.2 mm (0.05λ_{g}) wide (in the transverse direction) rectangular slots 40a-40f each one of six slots 40 constituting a slot antenna providing microwave communication from inner volume 36 to outside slotted waveguide 20, each slot antenna 40 being suitable for radiation of microwaves having the 2.45 GHz frequency of microwaves generated by magnetron 18 in the direction of vertical axis 26. All of slots 40a-40f were oriented parallel to longitudinal axis 22, and the centerlines of slots 40a-40f were all 13 mm from the longitudinal centerline of bottom panel 34.

Since waveguide 20 was configured to be a resonant waveguide, slot antennas 40a-40f were arranged on bottom panel 34 in two staggered parallel rows, each slot at a different minimum/maximum of the standing wave formed inside waveguide 20: in a first row 40a. 40c and 40e centered at 123 mm (0.75λ_{g}), 287 mm (1.75λ_{g}), 451 mm (2.75λ_{g}) respectively from proximal end 38 and in a second row 40b, 40d and 40f centered at 205 mm (1.25λ_{g}), 369 mm (2.25λ_{g}), 533 mm (3.25λ_{g}) from proximal end 38. There was no slot present across from the aperture of magnetron 18 at 0.25λ_{g}.

Device 10 was man-portable. For use, a person held device 10 by handle 12b with bottom panel 34 directed downwards with vertical axis 26 substantially perpendicular to the ground so that microwaves radiated from slot antennas 40 were directed exclusively at the ground.

### Microwave Generator

As noted above, a device according to the teachings herein comprises a microwave generator physically associated with the slotted waveguide so that an aperture of the microwave generator introduces microwaves generated by the microwave generator into the waveguide inner volume.

In preferred embodiments, the physical association is such that the aperture of the microwave generator introduces the generated microwaves at or near either the distal or proximal end of the slotted waveguide, as depicted for device 10 in FIG. 1. As discussed above, in some preferred embodiments the microwaves are introduced at or close to a maximum or minimum of the wave that is formed when the microwave generator is operated.

Any suitable microwave generator can be used, for example, a magnetron such as a cavity magnetron.

The microwave generator is configured to generate microwaves having any suitable frequency. Microwaves having frequencies that are highly absorbed by the water present in the meristem of a plant or in the bodies of arthropods are preferred, i.e., higher frequencies are preferred. In some embodiments the frequency is selected from the group consisting of 915 MHz and 2.45 GHz.

A microwave generator requiring any suitable input power for operation may be used. Preferably, the microwave generator is relatively small, light, cheap and/or requires a low input power for operation. Accordingly, in some embodiments, the microwave generator requires not more than 10 kW power for operation, not more than 8 kW, not more than 6 kW, not more than 4 kW, not more than 2.2 kW, not more than 1.6 kW, not more than 1.2 kW, not more than 1.0 kW and even not more than 0.8 kW, including microwave generators that require about 0.5 kW. In some embodiments, such low-power microwave generators can be used because only heating of the meristem of a plant is desired. In some embodiments, such low-power microwave generators can be used because only a low amount of energy is required to damage an arthropod. In some embodiments, such low-power microwave generators allow a device to be mobile, even man-portable, and/or cheap to acquire and operator, inter alia because only a modest electrical power supply is required to operate the device.

The power output of the microwave generator is any suitable power output. In some embodiments, the power output of the microwave generator and the number of slot antennas is such that when the device is operated the total flux per slot antenna is not greater than 1000 W, not greater than 800 W, not greater than 600 W, not greater than 400 W and even not greater than 200 W. Typically, the total flux per slot antenna is not less than 50 W.

As discussed with reference to FIG. 1 and in the Experimental Section, device 10 comprised, as a microwave generator, a cavity magnetron 18 generating 2.45 GHz microwaves and requiring 1.1 kW input power for operation, with a power output of 900 W, the device having six slot antennas so that the total flux per slot antenna was 150 W.

### Number of Microwave Generators

As noted above, a device includes a slotted microwave waveguide physically associated with the waveguide so that an aperture of the microwave generator introduces generated microwaves into the waveguide inner volume.

In some embodiments, a device comprises at least one slotted microwave waveguide with a single microwave generator associated therewith, e.g., device 10 depicted in FIG. 1.

Known magnetrons require a power supply including a ˜4 kV transformer to supply sufficient electrical power at the correct voltage for continuous operation. Since such transformers are very expensive and relatively large, magnetrons are often provided with a power supply including a ˜2 kV transformer and a capacitor. During operation, half of the time the transformer is used to charge the capacitor and the other half of the time both the transformer and the capacitor are used to power the magnetron. In such a way, a magnetron is provided with a power supply that includes a cheap and compact ˜2 kV transformer but has only a 50% duty cycle. To overcome disadvantages associated with a 50% duty cycle, in some embodiments, a device according to the teachings herein having a microwave waveguide dimensioned to be resonant with the microwaves having the specified wavelength generated by the microwave generator includes two microwave generators (e.g., two magnetrons), both physically associated with the same slotted microwave waveguide. The two microwave generators are operated to alternately generate microwave radiation so that the device has a 100% duty cycle even if each individual magnetron has a duty cycle of only 50%. An additional advantage is that irradiated plants or arthropods are continuously heated so the time required to reach a required temperature is reduced. Preferably, the microwaves from each magnetron are introduced from opposite ends of the slotted waveguide (from one at or near the distal end, from the other at or near the proximal end) so that the average microwave radiation from all the slot antennas is doubled. As discussed above, preferably both the first microwave generator and the second microwave generator introduce microwaves at or close to a minimum/maximum of the standing wave formed in the inner volume, e.g., a first microwave generator introduces microwaves 0.25λ_{g} from a proximal end of the inner volume of the slotted waveguide and a second microwave generator introduces microwaves at 0.25λ_{g} from a distal end of the inner volume of the slotted waveguide so that all generated microwaves are introduced at a maximum/minimum of the standing wave that will be formed when the microwave generators are operated.

Accordingly, in some embodiments, a device further comprises a second microwave generator for generating microwaves having the specified frequency, physically associated with the slotted microwave waveguide so that the aperture of the second microwave generator directs microwaves generated by the second microwave generator into the inner volume of the slotted waveguide. In some preferred embodiments, the physical association of the two microwave generators with the slotted waveguide is such that the aperture of one microwave generator directs generated microwaves near the proximal end of the inner volumed of the slotted waveguide (in some preferred embodiments, 0.25λ_{g} from the proximal end) and the aperture of the other microwave generator directs generated microwaves near the distal end of the inner volume of the slotted waveguide (in some preferred embodiments, 0.25λ_{g} from the distal end). In some such embodiments, both the microwave generators are magnetrons, e.g., cavity magnetrons. In some such embodiments, each one of the two microwave generators comprise a power supply providing power at a voltage of less than 3 kV. In some embodiments, each one of the two microwave generators has a 50% duty cycle and the device is configured so that the two microwave generators are alternately operated so that microwaves are continuously radiated from the slot antennas.

An embodiment of an embodiment of a device 42 suitable for irradiation of plants or items potentially-infested with arthropods with microwaves according to the teachings herein comprising a slotted microwave waveguide 44 is depicted, in FIG. 2A (side cross section) and FIG. 2B (view from the bottom) comprising a first cavity magnetron 18a and a second cavity magnetron 18b. Both magnetrons 18 generate microwaves having the same specified frequency and waveguide 44 is configured to be resonant with microwaves having the specified frequency. First cavity magnetron 18a is directly physically associated with slotted waveguide 44 near a proximal end 38 (at 0.25λ_{g}) from proximal end 38) and second cavity magnetron 18b is directly associated with slotted waveguide 44 near a distal end 46 (at 0.25λ_{g} from distal end 46), both magnetrons 18 directly physically associated with slotted waveguide 44 so that the respective apertures introduce generated microwaves directly into an inner volume 36 of slotted waveguide 46. Each one of magnetrons 18a and 18b is substantially identical to magnetron 18 described with reference to FIG. 1 and receives power from an associated 2 kV transformer 48a or 48b, respectively.

The width and height dimensions of an inner volume 36 of slotted waveguide 44 are the same as those of slotted waveguide 20 discussed with reference to FIG. 1 but the length is 4.0% in order accommodate second cavity magnetron 18b. The panels making up waveguide 44 are made of glass-reinforced PTFE which inner surfaces are coated with graphene (in the form of graphene suspended in an adhesive such as Permabond® POP by Permabond Engineering Adhesives Ltd., Colden, Common, Hampshire, The United Kingdom). Slot antennas 40a-40f of slotted waveguide 44 are regions of the inner surface of a bottom panel 34 devoid of graphene coating. As discussed for device 10 with reference to FIGS. 1, slot antennas 40a-40f of slotted waveguide 44 are arranged in two parallel staggered rows, where slot antennas 40a, 40c and 40e of the first row are mutually colinear and offset from a longitudinal centerline 42 of bottom panel 34 by 13 mm and slots 40b, 40d and 40f of the second row are mutually colinear and offset from longitudinal centerline 42 by 13 mm. All slot antennas 40a-40f of slotted waveguide 44 are centered at a maximum/minimum of the standing wave that will be formed when the microwave generators are operated.

Device 42 comprises a controller 16 that is configured to alternatingly activate magnetrons 18a and 18b providing a 100% duty cycle where microwaves are continuously radiated from slot antennas 40a-40f. Since slotted waveguide 44 is a resonant waveguide and slot antennas 40 are all equidistant from the longitudinal centerline of slotted waveguide 44, the emission intensity from all six slot antennas 40 is identical.

### Slotted Microwave Waveguide

As noted above, a device according to the teachings herein comprises a slotted microwave waveguide. A slotted microwave waveguide is known in the art, being a straight hollow conductor, the inner volume of the waveguide having:
three mutually-perpendicular dimensions: a length dimension along a longitudinal axis, a width dimension along a lateral axis, and a height dimension along a vertical axis, and
one or more slot antennas providing microwave communication from the inner volume to outside the waveguide, each slot antenna being suitable for radiation of microwaves having the frequency of microwaves generated by the microwave generator in a direction within 20° parallel to the vertical axis.

### Slotted Waveguide Material

The walls of the slotted waveguide are made of any suitable material as known in the art of slotted microwave waveguides. Typically, the walls of the slotted waveguide are of a conductive material, e.g., a metal, graphite, graphene. In some embodiments (e.g., some embodiments where the walls of the slotted waveguide are of metal such as device 10 of FIG. 1), the slotted waveguide is self-supporting and the walls define the shape and dimensions of the inner volume. In some embodiments (e.g., some embodiments where the walls of the slotted waveguide are of graphite or graphene, such as device 42 of FIG. 2) the walls of the slotted waveguide are a coating on a frame (e.g., plastic panels or tubing) that defines the shape and dimensions of the inner volume.

In some embodiments, the inner surfaces of the walls of the slotted waveguide that face the inner volume are bare conductive material while in other embodiments the inner surfaces of walls of the slotted the waveguide are at least partially covered with a microwave-transparent material, e.g., a protective coating over the conductive material. In some embodiments, the outer surfaces of the slotted waveguide are bare conductive material while in other embodiments the outer surfaces of the walls of the slotted waveguide are at least partially covered, e.g., with a protective material such as a paint or lacquer.

As noted above, for resonant slotted waveguides, the two longitudinal end panels are microwave reflective. For non-resonant slotted waveguides, the proximal longitudinal end panel close to the location of introduction of microwaves is microwave reflective while the distal longitudinal end of the waveguide is optionally devoid of an end panel and is open, or includes a microwave non-reflective end panel. Such a microwave-non-reflective end panel is optionally microwave absorbant.

### Inner Volume of the Slotted Waveguide

In some embodiments, the inner volume of the slotted waveguide is at least partially filled with a microwave-transparent solid material, e.g., plastic, styrofoam. In preferred embodiments, the inner volume of the slotted waveguide is filled with a gas such as air.

### Dimensions of the Inner Volume of the Slotted Waveguide

The inner volume of the slotted waveguide has three mutually-perpendicular dimensions, a length dimension along a longitudinal axis of the inner volume, a width dimension along a lateral axis of the inner volume, and a height dimension along a vertical axis of the inner volume.

For non-resonant waveguides, the length (L) of the inner volume is any suitable length. For resonant waveguides, the length (L) of the inner volume is such that the inner volume is resonant with λ_{g}. Specifically, in preferred embodiments the length of the inner volume is an integral multiple of half a wavelength of λ_{g}, i.e., L=λ_{g}/2*n where n is any integer greater than 0, so that the length dimension of the inner volume of the slotted waveguide defines and is parallel to the longitudinal mode of microwave propagation in the inner volume. The specific n and length L for any given embodiment are typically selected for convenient construction and/or use of the device.

The width (W) of the inner volume of the waveguide is any suitable width as known to a person having ordinary skill in the art and, as noted above, largely determines λ_{g}. For both resonant and non-resonant waveguides, it is preferred that the microwaves propagating in the waveguide have a single transverse mode in the width dimension so the width of the inner volume is greater than or equal to half λg and is less than or equal to λ_{g}, i.e., λ_{g}/2≤W≤λ_{g}. In device 10 discussed with reference to FIGS. 1, the width W was 0.56λ_{g}.

The height (H) of the inner volume of the waveguide is any suitable height as known to a person having ordinary skill in the art. For both resonant and non-resonant waveguides, it is preferred that the height is less than or equal to half λ_{g}, i.e., H≤λ_{g}/2 so that the microwaves propagating in the inner volume have no transverse modes in the height dimension. In device 10 discussed with reference to FIGS. 1, the height H was 0.26λ_{g}.

### Required Precision of Dimensions of the Slotted Microwave Waveguide

The preferred dimensions of various components of the slotted microwave waveguide are as known in the art, some of which are recited above, as related to λ_{g}. Dimensions specifically recited herein include the height, width and length dimensions of the inner volume of the waveguide as well as of the dimensions of the slot antennas, see below.

As known in the art of slotted microwave waveguides, the required precision for these dimensions is typically 10% or better of the dimension related relative to λ_{g}, i.e., a dimension recited as 0.5λ_{g} is still useful when implemented at any value 0.5λ_{g}±10% (0.45λ_{g} to 0.55λ_{g}), although the closer to the recited value, the better. Accordingly, in some embodiments, the height, width and length dimensions of the inner volume and the dimensions of the slot antennas are ±5%, ±4%, ±3% and even ±2% of the recited above. Precisions that are greater than 10% up to 20% are still workable, but lead to substantial conversion of microwave energy to heat, and may lead to inhomogeneous radiation from the antennas so that hot or cold spots may appear in the near field.

### Non-Resonant Slotted Microwave Waveguide

As noted above, in some embodiments a device comprises a non-resonant microwave waveguide. An embodiment of such a device, device 49 with non-resonant waveguide 51 is depicted in FIG. 2C in side cross-section and in FIG. 2D in a view from the bottom. Waveguide 51 appears superficially similar to resonant waveguide 20 depicted in FIG. 1 with a few important differences.

In non-resonant waveguide 51, proximal longitudinal end panel 30a near microwave generator 18 is microwave reflective but distal longitudinal end panel 30b is not reflective, in some embodiments being microwave transparent and in other embodiments being microwave absorbant. In some embodiments of a non-resonant waveguide, there is no distal longitudinal end panel and the distal longitudinal end of the waveguide is open.

In resonant waveguide 20, slots 40 are located at the same distance from the centerline of the bottom surface of the waveguide so that the electrical field radiated from each slot antenna 40 is identical. In non-resonant waveguide 51, slots 40 are located at different distances from the centerline of the bottom surface of the waveguide, slots closer to microwave generator 18 being closer to the centerline and slots farther from microwave generator 18 being farther from the centerline, such differential distance being calculated so that the electrical field radiated from each slot antenna 40 is close to being identical.

The dimensions and positions of slot antennas 40 are also such that as much of the energy as possible that is introduced by microwave generator 18 into inner volume 36 is radiated from slot antennas 40 so that little or no energy reaches the distal end (end panel 30b).

### Shape of the Inner Volume of the Waveguide

The shape of the inner volume of the waveguide is any suitable shape and, in cross section preferably has a height dimension H and a width dimension W as discussed above.

In some embodiments, in cross section perpendicular to the longitudinal axis the inner volume is a circle or oval having dimensions W×H so that the slotted waveguide is a tubular slotted microwave waveguide. In FIG. 3A, a tubular slotted waveguide 50 with a circular cross section is depicted in cross section perpendicular to a longitudinal axis 22 having a single row of slot antennas 40 (only one slot antenna 40 is seen in the figure). In embodiments where the cross section is oval, the width W is greater than the height H and microwaves are radiated from a “flatter” side of the waveguide, substantially perpendicularly to the longitudinal and lateral axes and parallel to the vertical axis. In FIG. 3B, a tubular slotted waveguide 52 with an oval cross section is depicted in cross section perpendicular to a longitudinal axis 22 having two staggered row of slot antennas 40, only single slot antenna 40 is seen in FIG. 3B.

In preferred embodiments, in cross section perpendicular to the longitudinal axis the inner volume is a square or rectangle having dimensions W×H so that the slotted waveguide is a rectangular slotted microwave waveguide. In such embodiments, microwaves are preferably radiated perpendicularly from a face of the waveguide having a length L and a width W perpendicularly to the longitudinal and lateral axes and parallel to the vertical axis, see for example, waveguide 20 of device 10 depicted FIG. 1 and waveguide 44 of device 42 depicted FIG. 2.

### Slot Antennas

As noted above, a device according to the teachings herein comprises a slotted microwave waveguide including at least one slot antenna configured to radiate microwaves having the frequency of microwaves generated by the microwave generator from the inner volume of the slotted waveguide.

### Dimensions and Positions of Slot Antennas

The shape of the slot antennas is preferably rectangular, having a smaller width dimension and a larger length dimension parallel to the longitudinal axis of the waveguide. The dimensions of a rectangular slot antenna (length and width) are standard dimensions as known in the art of slotted microwave waveguides. In some embodiments, the length of the slot antenna is λ_{g}/2±20% in parallel to the longitudinal mode (longitudinal axis) of the slotted waveguide inner volume. In waveguide 20 of device 10 depicted in FIGS. 1, the slot antennas are 61 mm long (0.5λ_{f}) and 8.2 mm wide (0.0.05λ_{g}).

Generally, it is preferred that the corners of a rectangular slot antenna be square, but in some embodiments the corners of a slot antenna are rounded due to machining constraints. In device 10 depicted in FIGS. 1, slot antennas 40 are rounded rectangles as these are made using a machine tool such as an end mill. In device 42 depicted in FIGS. 2, slot antennas 40 are square-cornered rectangles as these are made by applying a graphene-impregnated adhesive to an inner surface of bottom panel 34, portions of which are covered with a rectangular stencil.

As discussed above, the longitudinal position of the slot antennas are standard positions as known in the art of slotted microwave waveguides, typically each slot being centered at a maximum or minimum of the wave in the waveguide.

The number of slot antennas and the arrangement of the slot antennas of the waveguide is any suitable number and arrangement of slot antennas and can be determined by a person having ordinary skill in the art subsequent to study of the disclosure herein. Typically factors influencing the number of slot antenna include the output power of the microwave generator and the desired flux per slot antenna. As is discussed in greater detail hereinbelow, in some preferred embodiments, a waveguide includes a single slot antenna and in other preferred embodiments a waveguide includes at least two slot antennas, in preferred embodiments the at least two slot antennas staggered on the two different sides of the centerline of the waveguide.

### Multiple-Slot Antennas

In some embodiments, a slotted waveguide of a device according to the teachings herein includes two or more slot antennas.

Preferably, in embodiments having two or more slot antennas, all the slot antennas are located on a single side of the waveguide so that the microwaves radiated by all the slot antennas are radiated in the same direction within 20° of the vertical axis. For rectangular slotted microwave waveguides, it is preferred that all slot antennas are positioned on the same face of the slotted waveguide, preferably a face of a bottom surface having a length by width dimension, for example as in device 10 depicted in FIG. 1. For tubular slotted microwave waveguides having an oval cross section, it is preferred that all slot antennas are positioned as close as possible on the same flatter side of the waveguide, for example waveguide 52 depicted in FIG. 3B.

In some embodiments, there are two or more slot antennas arranged in a single row along a line parallel to the longitudinal axis of the waveguide, for example, as in circular-crossection waveguide 50 depicted in FIG. 3A. A potential disadvantage of some such embodiments is, due to the required length of the slot antennas and the positioning of the slot antennas as discussed above, there are gaps in the near-field with little or no radiated energy, creating cold spots at a designated irradiation distance. In some such embodiments, a device includes two different waveguides each with an associated microwave generator and each having a single row of slot antennas. The two waveguides are arranged in the device so that the two rows of slot antennas are staggered so that cold spots in the irradiation pattern of a first waveguide are irradiated by the second waveguide. In some such embodiments, the two waveguides are oriented so that the emission-direction of radiation from the antennas of the first waveguide and the emission-direction of radiation from the antennas of the second waveguide converge. During use of such embodiments, the outer faces of the slot antennas are preferably maintained at an offset distance from an item, plant or surface being irradiated so that the offset distance the electric field produced by the two waveguides each having a single row of slot antennas has a high-intensity contiguous region.

In some embodiments, a single waveguide comprises two or more slot antennas arranged in two different staggered rows, the rows on different sides of the centerline of the waveguide, as described above. An advantage of such an embodiments is, as described in the Experimental Section, the staggering of the two rows of slot antennas allows the electric fields radiated from the individual slot antennas to overlap at a certain designated irradiation distance, preferably at a distance that is within the near-field of the slotted waveguide, thereby helping prevent hot spots/cold spots at the designated irradiation distance so that at the designated irradiation distance the combined electric field produced by the antennas has a high-intensity contiguous region.

Accordingly, in some embodiments the slotted waveguide includes two or more slot antennas, arranged in two staggered rows, each one of the two rows on a different side of the plane defined by the vertical axis and the longitudinal axis of the waveguide as in device 10 depicted in FIG. 1. Some such embodiments are exceptionally useful for indiscriminately irradiating a surface with microwaves to irradiate undesirable plants growing from the surface or to irradiate an item that is potentially infested with arthropods. During use of such embodiments, the outer faces of the slot antennas are preferably maintained at an offset distance (more or less being the designated irradiation distance) from a surface being irradiated so that at the surface the electric field produced by the waveguide has a high-intensity contiguous region where all portions of the contiguous region have an intensity of ±20% of the average intensity of the region. In some embodiments, all portions of the contiguous region have an intensity of +15% and even ±10% of the average intensity of the region. Preferably, the offset distance is such that the surface is within the near-field region of the slotted waveguide. In some embodiments, the components of the device, including the microwave generator, are configured so that the average intensity of the contiguous region is not less than 40 V/m, not less than 50 V/m, not less than 60 V/m and even not less than 70 V/m. Typically, the average intensity is not greater than 120 V/m. Details of such an embodiments and the use thereof is described with reference to the method of the teachings herein and is discussed in detail in the Experimental Section with reference to device 10 depicted in FIG. 1.

In some embodiments where the slot antennas are arranged in a single row or the slot antennas are arranged in two staggered rows, the axes of the slot antennas in a given row are colinear, for example, in waveguide 20 of device 10 (FIGS. 1A, 1B, 1C), waveguide 44 of device 42 (FIGS. 2A and 2B) and slotted oval waveguide 52 (FIG. 3B). Such embodiments are preferred for resonant waveguides as, given that each slot antenna has the same dimensions, the intensity of the electric field radiated by all the slot antennas is the same. In this context, the term “the intensity of the electric field radiated by all the slot antennas is the same” means within ±20%, and in some embodiments within ±15% and even within ±10% of the average intensity of the electric field radiated from all of the slot antennas. A potential disadvantage of some such embodiments where the slotted waveguide is non-resonant is that the intensity of the electric field radiated by each individual slot antenna is not identical, with greater field intensity from antennas close to the microwave generator aperture and lower field intensity from antennas far from the microwave generator aperture.

In some embodiments, especially where the waveguide is a non-resonant waveguide, where multiple slot antennas are arranged in two staggered rows, the distance of each slot antenna from the longitudinal center line of the slotted waveguide is different such that the intensity of the electric field radiated by each individual slot antenna is the same (as defined above). Such an embodiment is exemplified in device 49 depicted in FIGS. 2C and 2D where slot antennas 40a and 40b that are close to reflective proximal end 38 of non-resonant waveguide 51 are relatively close to the centerline of bottom panel 34 while slot antennas 40e and 40f that are close to the distal end of non-resonant waveguide 51 are relatively far from to the centerline of bottom panel 34.

### Single-Slot Antenna

In some preferred embodiments, a slotted waveguide includes only one slot antenna. In preferred such embodiments, the waveguide is a resonant waveguide and the length L of the inner volume of the waveguide is 0.5λ_{g}. Some such embodiments are exceptionally suitable for selective irradiation of a single identified plant since all the radiated microwaves are radiated from the single slot antenna, allowing a single plant to be irradiated for a shorter time and/or for the microwave generator to require less power compared to embodiments having multiple slot antennas. Some such embodiments are exceptionally advantageous: all the energy introduced into the waveguide is radiated from a single slot antenna so the intensity is high, allowing quick treatment of plants/items potentially infested with arthropods; some such embodiments are exceptionally cheap and easy to make using cheap and readily available microwave generators such as magnetrons used in the field of microwave ovens; some such embodiments are relatively small, lightweight and have modest power requirements for operation so can be easily be integrated in other systems such as household robots, e.g. for treating an item such as a carpet or rug potentially infested with arthropods, a user can configure a device comprising one or more waveguides together, e.g., in one or multiple rows, each waveguide with a single slot and associated microwave generator. When arranged in one or multiple rows, such waveguides are preferably configured so that the electrical fields of any two neighboring waveguides overlap at a designated irradiation distance to provide a high-intensity contiguous region as described above. Such configuration allows creation of such a high-intensity contiguous region of any desired length by assembling a suitable number of cheap building blocks (a cheap microwave generator functionally associated with a cheap, simple and small single-slot waveguide) in a row. In such a way, a device can be customized to treat substantially any width desired, e.g., for treating plants in different-width furrows or for treating items such as carpets, passageways, beds which come in a variety of sizes (typically, 80 cm to 200 cm).

In FIGS. 4A and 4B, a rectangular slotted waveguide 54 with a rectangular cross section is depicted in side cross section (FIG. 4A) and from the bottom (FIG. 4B) that was actually built by the Inventors. Slotted waveguide 54 was physically associated with a magnetron 18 with power supply including a transformer as a microwave generator from a standard commercially-available 2.0 kW microwave oven that generated 1.8 kW of 2.45 GHz (λ_{f}=122 mm). Slotted waveguide 54 was made of six aluminum panels, two end panels 30 that were 48 mm high by 98 mm wide, two side panels 28 that were 48 mm high by 82 mm long and a top panel 32 and a bottom panel 34 that were both 92 mm wide and 82 mm long, assembled so as to constitute a hollow rectangular cuboid slotted waveguide 54 having an inner volume 36 82 mm (0.5λ_{g}) long in the longitudinal direction, 92 mm (0.56λ_{g}) wide in the transverse direction and 42 mm (0.26λ_{g}) high in the vertical dimension, inner volume 36 being resonant with the 2.45 GHz frequency of microwaves generated by magnetron 18.

Centered on the longtudinal axis of and 41 mm (0.25λ_{g}) from the proximal end of top panel 32, a 30 mm diameter circular hole passed through top panel 32 to accept an aperture of magnetron 18 so that when magnetron 18 was activated, generated microwaves were directly introduced into inner volume 36 at a distance of 0.25λ_{g}, from the proximal end of inner volume 36. In such a way, magnetron 18 introduced generated microwaves at a maximum of the standing wave formed inside waveguide 20.

Passing through bottom panel 34 was a single 61 mm (0.5λ_{f}) long (in the longitudinal direction) by 8.2 mm (0.05λ_{g}) wide (in the transverse direction) slot 40 constituting a slot antenna providing microwave communication from inner volume 36 to outside slotted waveguide 54, slot antenna 40 being suitable for radiation of microwaves having the 2.45 GHz frequency of microwaves generated by magnetron 18 in the direction of vertical axis 26. Longitudinally, slot antenna 40 was located in the center of inner volume 76 so that the center of the slot was at the maximum (0.25λ_{g}) of the standing wave formed when magnetron 18 was activated. The centerline of slot antenna 40 was 20 mm from the centerline of bottom panel 34 (where the plane defined by longitudinal axis 22 and vertical axis 26 bisects bottom panel 34). Further features that appear in FIGS. 4A and 4B are discussed hereinbelow.

### Thickness of Slot Antenna

In some embodiments, a slot antenna is substantially a slot cut out of the material which makes up the wall of slotted waveguide, the thickness of the material defining the height of the slot antenna (the dimension substantially parallel to the height of the slotted waveguide), for example, in slotted waveguide 20 of device 10 depicted in FIG. 1. It is generally preferred that the height of a slot antenna be as small as possible, preferably infinitely small. In practice, a very thin slot antenna is difficult to make by removing material from a wall, is physically weak and is susceptible to damage. Accordingly, in some embodiments, at least one, preferably all, slot antenna includes an inset periphery, see FIG. 5A depicting a single slot antenna 40 of device 10 depicted in FIG. 1 in side cross section. From FIG. 5A is seen that an inner side 56 of slotted waveguide 20 is smooth with no steps in proximity of slot antenna 40 but an outer side 58 of slotted waveguide 20 is inset in proximity of an outer periphery 60 of slot antenna 40. As noted above, the thickness of the walls of slotted waveguide 20 is 3 mm but the inset portion is only 1 mm thick. The length of the inset portion is 3 mm.

In some embodiments such as depicted in FIGS. 2, slot antennas 40 of slotted waveguide 44 are gaps in a thin graphene layer so are very thin.

### Open or Covered Slot Antenna

In some embodiments, one or more of the slot antennas is an open hole allowing fluid communication between the ambient air and the slotted waveguide inner volume, see for example, slot antennas 40 depicted in FIG. 5A.

In some embodiments, one or more of the slot antenna is at least partially (preferably completely) covered with a microwave-transparent material, e.g., polytetrafluoroethylene, glass, plastic, glass-reinforced plastic. Such a cover prevents the entrance of contamination into the slotted waveguide inner volume and, in some embodiments, provides physical support and prevents damage to the edges of a slot antenna. In FIG. 5B is depicted a slot antenna 40 identical to slot antenna 40 depicted in FIG. 5A but with a two-part snap-fit PTFE plug 62 which prevents entry of contamination into inner volume 36 and protects the inset portion near the periphery of slot antenna 40 from physical damage

### Controllable Slot Shutter

In some embodiments, the device further comprises a controllable slot shutter functionally associated with a slot antenna, the slot shutter having at least two states:
an open state during which microwaves can pass from the inner volume of the slotted waveguide through the slot antenna, and
a closed state during which microwaves cannot pass from the inner volume of the slotted waveguide through the slot antenna.

In some embodiments, all slot antennas of a device are functionally associated with a slot shutter. In some embodiments, one or some, but not all slot antennas of a device are functionally associated with a slot shutter.

In some embodiments, a group or all slot shutters of a device are together either in a closed state or in an open state. In some embodiments, each slot shutter is independently controllable to be in a closed state or to be in an open state.

In some embodiments, a slot antenna with a functionally-associated slot shutter is covered with a microwave-transparent material, In some embodiments, a slot antenna with a functionally associated slot shutter is open and not covered with a microwave-transparent material.

In some embodiments, a slot shutter is normally biased to the closed state, e.g., with a spring and is actively move to an open state, e.g., with an electric motor.

In some embodiments, a slot shutter is normally biased to the open state, e.g., with a spring, and is actively moved to a closed state, e.g., with an electric motor.

In some embodiments, a slot shutter is actively moved from the open state to the closed state and from the closed state to the open state, e.g., with an electric motor.

In FIG. 6 is depicted a slotted waveguide 64 viewed from the bottom. Slotted waveguide is substantially identical to slotted waveguide 10 depicted in FIG. 1 but further including six controllable slot shutters 66a-66f each functionally associated with a respective one of six slot antennas 40, Each slot shutter 66 comprises an electrical motor that can be activated to move a cover panel over an associated slot antenna 40 so that slot shutter 66 is in a closed state (e.g., 66a) or activated to move a cover panel away from a respective slot antenna 40 so that the slot shutter is in an open state (e.g., 66b-66f). Each one of slot covers 66a-66f is independently controllable by controller 16. Further features that appear in FIG. 6 are discussed hereinbelow.

### Number of Waveguides

As noted above, a device suitable for irradiation of plants with microwaves according to the teachings herein includes a slotted microwave waveguide physically associated with a microwave generator so that an aperture of the microwave generator directs generated microwaves into the slotted waveguide inner volume.

In some embodiments, a device comprises only one slotted microwave waveguide with one or more microwave generators associated with the waveguide, for example, device 10 depicted in FIG. 1 or device 42 depicted in FIG. 2.

As will be discussed in greater detail below, the microwave power radiated from each slot antenna of a slotted waveguide is dependent on the number of slot antennas as well as the total output of the microwave generators. The power radiated from each slot antenna determines the duration which a given plant or item must be irradiated in order to achieve a desired effect which determines the rate at which a given area can be treated according to the teachings herein. In principle, if greater power emission is required it is possible to simply provide a microwave generator with a greater power output but in some embodiments this is less desirable as the required components (including microwave generator and power supply) will become more expensive and heavier.

An advantage of some embodiments of the teachings herein is that each slotted waveguide with associated microwave generator can be considered an independent module and a given device can include multiple such independent modules.

Accordingly, in some embodiments, a device comprising a slotted microwave waveguide and physically-associated microwave generator further comprises at least one additional slotted microwave waveguide physically associated with a different microwave generator so that an aperture of a given microwave generator directs generated microwaves into a slotted waveguide inner volume with which physically associated.

In some preferred embodiments, the vertical axes of the different slotted waveguides are substantially parallel (i.e., in some embodiments within ±15°, ±10° and even ±5° of parallel) so that microwaves are radiated from the different slotted waveguides in the same direction. In some such embodiments, at least two different slotted waveguides are configured and positioned so that when operated each one produces an electric field, the sum of the electric fields having a high-intensity contiguous region at a designated offset distance.

In some alternative embodiments, the vertical axes of the different slotted waveguides are not parallel but converge one towards the other (i.e., in some embodiments ±30°, ±20°, ±15°, ±10° and even ±5° of parallel) so that microwaves are radiated from the different slotted waveguides towards the same region in the same direction. In some such embodiments, at least two different slotted waveguides are configured and positioned including the converging vertical axes so that when operated each produces an electric field, the sum of the electric fields having a high-intensity contiguous region at a designated offset distance.

Accordingly, in some embodiments, a device according to the teachings herein comprises multiple (two or more) different slotted microwave waveguides each with an associated magnetron generator. In some embodiments, two or more slotted microwave waveguides of a device are identical. In some embodiments, two or more slotted microwave waveguides of a device are different.

In some embodiments, the longitudinal axes of two or more slotted microwave waveguides are parallel (i.e., the angle between the two longitudinal axes is ±15°, ±10′ and even ±5°) and in some embodiments parallel and colinear.

In FIG. 7A, a device 68 for irradiating plants is depicted from the top showing two slotted waveguides 20a and 20b identical to slotted waveguide 20 depicted in FIG. 1, where the respective longitudinal axes 22 are parallel and colinear. Device 68 further comprises a support structure 12 with wheel 70. A support structure 12 comprises a bracket allowing securing device 68 to a vehicle such as a tractor to tow device 68 in the direction of lateral axes 24a and 24b over an area where the outer bottom surface of device 68 bearing the slot antennas is facing the ground and wheel 70 ensures that the bottom surface is maintained 5 cm from the ground. An advantage of embodiments such as device 68 is that a broader swath of ground can be irradiated in a single pass while maintaining a required irradiation intensity without necessitating provision of a larger microwave generator. Since device 68 uses slotted waveguides 20a and 20b which slot antenna are arranged so that there is a relatively low intensity electric field in the area between the two waveguides 20a and 20b, so that in some uses device 68 may need to be passed over the same swath of ground twice. In alternate embodiments similar to device 68, slotted waveguides configured for radiating electric fields with overlapping regions of sufficient intensity in the longitudinal axis are used.

In FIG. 7B, a device 72 is depicted from the top showing two slotted waveguides 20a and 20b identical to slotted waveguide 20 depicted in FIG. 1, where the respective longitudinal axes 22 are parallel but not colinear. Device 72 is similar to device 68 but waveguides 20a and 20b are arranged so that when device 72 is moved in the direction of lateral axes 24a and 24b a continuous swath of ground with a width of from the distal end of waveguide 20a to the distal end of waveguide 20b is irradiated at a sufficient intensity to effect plants in accordance with the teachings herein.

In FIG. 7C, a device 74 is depicted from the top showing two slotted waveguides 50a and 50b identical to slotted waveguide 50 depicted in FIG. 3C, where the respective longitudinal axes 22 are parallel but not colinear. As noted above, slotted waveguide 50 has only a single row of slot antennas. If a single slotted waveguide 50 is moved over a surface in the direction of lateral axis 24, there is a possibilty that, due to the gaps between two neighboring slot antenna, some portions of the surface would be insufficiently irradiated. In device 74 this possibilty is prevented by offsetting slotted waveguide 50b from 50a in the longitudinal direction (by 0.25 k). As a result, device 74 has two staggered rows of slot antennas each row in a different waveguide (50a, 50b) which are similar in effect to the two staggered rows of slot antennas in the same waveguide 20 depicted in FIG. 1. As a result, the slot antennas of device are configured and positioned to produce an electric field that irradiates a surface with a high-intensity contiguous region where all portions of the contiguous region have an intensity of ±20% of the average intensity of the region. As a result, when device 72 is passed over a surface in the direction of lateral axis 24, all portions of the surface are sufficiently irradiated. A support structure 12 comprises a supporting frame which secures device 74 to a wagon having four wheels 70, configured to maintain the slot antennas of waveguides 50 5 cm from and facing the ground so that the vertical axis of waveguides 50 is perpendicular therewith. In some embodiments, the wagon is configured to be towed. Alternatively, in some embodiments, the wagon includes components such as a motor so that supporting structure is a self-propelled vehicle and in some preferred embodiments a robotic vehicle.

In FIG. 7D, a device 120 according to the teachings herein is depicted from the top. Device 120 comprises as a supporting structure 122 substantially a household robot similar to Roomba® robots by iRobot Corp. (Bedford Mass. USA) and includes a vacuuming module 124 that is configured to clean carpets, parkets and similar items as known in the art of vacuum cleaning. Further, device 120 includes a single-slot waveguide 54 with associated microwave generator 18 such as depicted in FIG. 4. The clearance of the bottom surface of device 120 from the ground is typically as low was possible so that device 120 is stable and can fit under furniture, typically less than 4 cm, less than 3 cm, and in some embodiments less than 2 cm. The face of the slot antennas is preferably elevated so that the effective electrical field in the longitudinal direction is as large as possible but small enough so that a surface over which device 120 rides while microwave generator 18 is activated is within the near field of a slot antenna 40 of waveguide 54. Using the integrated software well-known in the art of household vacuuming-robots, device 120 can be programmed to treat an item (e.g., the carpets and/or floors of a hotel or house) to ensure that these are clean and irradiated to a degree sufficient to control any potential arthropod infestation. Device 120 further includes brackets 126. Each bracket 126 is configured to reversibly hold an additional a single-slot waveguide 54 with associated microwave generator 18. If desired, an additional one or two waveguide 54 with associated microwave generator 18 is placed in one or both brackets 126, allowing device 120 to treat a broader swath of item at any one time then is possible with only one waveguide 54.

Some embodiments of a device according to the teachings herein are similar to device 120, include different or additional waveguides including waveguides with multiple slot antenna. Some embodiments of a device according to the teachings herein are similar to device 120 but include modules in addition to or instead of vacuuming module 122. Some embodiments of a device according to the teachings herein are similar to device 120 but only include treatment components necessary for control of arthropod infestations.

In FIG. 7E, a device 128 according to the teachings herein is depicted from the top. Device 128 is a device for treating items such as beds in accordance with the teachings herein to irradiate the top surface of the bed (including but not limited to a bare mattress, a mattress with sheet, a mattress with bed linen) to a degree sufficient to control any potential arthropod infestation. Device 128 includes as a supporting structure frame 130 made up of two sides 132a and 132b and a replaceable crossbar 134. Each side 132 include bar that is configured to reversibly engage crossbar 134 and two self-propelled wheels 136 (including an in-hub electrical drive motor that is activatable by wireless commands received from an appropriately-configured smartphone). Crossbar 134 depicted in FIG. 7E is 120 mm long and includes ten brackets 138, each bracket 138 configured to hold a single single-slot waveguide such as waveguide 54 with associated microwave generator 18 such as depicted in FIG. 4. The sides of two waveguides held in any two neighboring brackets contact. For use (e.g., in a hotel or similar) for controlling a potential arthropod infestation on a single bed (80 cm wide), an operator assembles device 128 with crossbar 134 and ten waveguides 54, wheels device 128 into a room, plugs device 128 into an electrical outlet and places device 128 to straddle a single bed with the slot antenna 5 cm above the surface of the bed. Using a smartphone, the operator activates the wheels of device 128 to drive at a rate of 1 cm per second while the antennas radiate microwaves. Since the bed is 190 cm long, the entire bed is treated in three minutes and 10 seconds while the operator does other things such as cleaning other parts of the room. The microwaves penetrate deep into the bed, killing or damaging at least some arthropods that are present in the bed. There is sufficient overlap of the electrical fields of any two neighboring slot antenna so that there are no cold spots where arthropods can retreat to avoid irradiation. If the operator subsequently wants to treat a different sized bed, it is a simple matter to replace crossbar 134 with a different crossbar that is long enough to straddle a different bed and support a sufficient number of waveguides. For example, to treat a 200 cm wide king-sized bed, a 240 cm long crossbar bearing 24 or 25 waveguides 54 can be used.

### Offset Distance

As discussed above, during some uses of the device, it is important to maintain a specified offset distance from some object, for example, from a plant or a surface being irradiated.

Accordingly, in some embodiments the device comprises an offset-mechanism configured to assist in maintaining the distance from the slotted waveguide to an object to be irradiated (e.g., the ground) within a predetermined range. In preferred embodiments, the predetermined range is within the near-field region of the slotted waveguide (i.e., not more than one wavelength from the slot antenna. e.g., 32.8 cm for 915 MHz microwaves and 12.2 cm for 2.45 GHz microwaves).

In some embodiments, the predetermined range is at least 2 cm, at least 3 cm and even at least 4 cm. In some embodiments, the predetermined range is not more than 60 cm, not more than 50 cm, not more than 45 cm, not more than 40 cm, not more than 32.8 cm, not more than 20 cm and even not more than not more than 12.2 cm.

In some embodiments, the device comprises a physical offset component. Such an offset component typically consists of one or more physical components extending from the device to a certain distance in the emission direction of one or more antennas. An offset components helps maintain the slot antennas at a desired range of distances from an object such as the ground. Examples of such physical offset components include elements of supporting structure 12 of devices 10, 68, 72, 74, 120 and 128.

In some embodiments, the device comprises a non-contact range finder to determine the distance from the slot antennas to an object, for example a surface. In some such embodiments, the non-contact range finder is functionally associated with a computer, the computer configured (using software, firmware, hardware and combinations thereof) to maintain at least one slot antenna at a desired offset distance from an object based on a range received from the non-contact range finder. Any suitable range finder may be used, for example, an ultrasonic, optical (such as a coincidence rangefinder or a stereoscopic rangefinder) or infrared rangefinder such as a Sharp GP2Y0A51SK0F Analog Distance Sensor capable of determining a distance in the range of 2 cm to 15 cm. Waveguide 54 depicted in FIG. 4 is associated with a non-contact optical stereoscopic rangefinder which determines a distance of slot antenna 40 from an object located on vertical axis 26 by calculating the parallax from two images acquired using cameras 76a and 76b. The range determined by the rangefinder is displayed to a user or is provided to a controller for use in operating components of the device.

### Orientation Determiner

During some uses of a device according to the teachings herein, it is useful to be able to determine the direction that microwaves are radiated from the slot antennas therefrom.

In some embodiments, a device further comprises an orientation determiner to determine the direction that microwaves of a slot antenna are radiated. In some embodiments, the device comprises a display which receives and displays a determined radiation-direction to a user. In some embodiments, the device comprises a controller which receives a determined radiation-direction as input for controlling other components of the device. For example, in some embodiments, if the radiation-direction is not towards the ground, the controller stops the radiation of all microwaves from the slotted waveguide, for example, by deactivating a microwave generator.

Any suitable orientation determiner can be used. In some embodiments, an orientation determiner comprises an accelerometer which can directly determine an orientation of a slotted waveguide (in a manner analogous to the known in the art of smartphones) and thereby the slot antennas and thereby the direction that microwaves are radiated.

In some embodiments, an orientation determiner comprises a light sensor, the light sensor configured, optionally together with a controller, to determine if the light sensor receives light that is not characteristic of being directed at the ground (e.g., brightness or spectral characteristics indicative of the light sensor being directed in parallel to the ground or at the sky). In some embodiments, such a light sensor is a non-imaging light sensor. In some embodiments, such a light sensor is an imaging light sensor such as a digital camera. Waveguide 54 depicted in FIG. 4 comprises a digital infrared imager 78 (e.g., PTi120 Pocket Thermal Imager by Fluke Europe B.V. Eindhoven, The Netherlands or a thermal imager by Qubit Phenomics Inc., Kingston, Ontario, Canada) which can acquire digital thermal images in the radiation-direction of waveguide 54 and also an optical range finder which component cameras 76a and 76b can provide digital visible light images of the direction in the radiation-direction of waveguide 54. One or more of such acquired images can be analyzed by an associated controller to determine the actual instantaneous radiation-direction of waveguide 54.

In some embodiments, an orientation determiner comprises a range-finder, for example, a non-contact range finder as discussed above. If a determined range is greater than a pre-determined threshold, it is accepted as indicating that the radiation-direction is not towards the ground. Waveguide 54 depicted in FIG. 4 comprises an optical range finder which can provide a determined range to a controller for use in determining a radiation-direction.

### Plant Identification

In some embodiments, a device comprises a light detector that is an imager such as a digital camera configured to capture an image in the radiation-direction which is provided to an associated controller, the controller configured (using software, firmware, hardware and combinations thereof) to identify an object detected by the imager.

In some embodiments, the controller is configured to identify a plant detected by the imager as an undesirable plant. In some such embodiments, the computer is configured to control components of the device (e.g., slot shutters, microwave generator) to irradiate or not irradiate a detected plant, e.g., to irradiate a plant that is identified as being undesirable (e.g., by activating a microwave generator, by ensuring that a slot shutter is in an open state) and/or to not irradiate a plant that is identified as being desirable (e.g., by not-activating a microwave generator, by ensuring that a slot shutter is in a closed state).

For example, a device comprising slotted waveguide 54 depicted in FIG. 4B includes an infra-red imager 78 as an imager. Images acquired by infra-red imager 78 are provided to an associated controller which is configured to determine by image analysis whether a plant appearing in the acquired image is an undesirable plant.

For example, a device comprising slotted waveguide 64 depicted in FIG. 6 includes six infrared imagers 78a-78f. In some embodiments during use, shutters 66 are all set to be in a closed state while waveguide 64 is moved in a lateral direction with slot antennas 40 directed at the ground. Each one of imagers 78 independently continuously acquires images of the ground and analyzes the acquired images for the presence of an undesirable plant. If an undesirable plant is identified by one of imagers 78, the respective shutter 66 is set to an open state so that the undesired plant is irradiated as waveguide 64 passes over the plant.

### Thermometer

As discussed with reference to the method for limiting the growth of plants discussed herein, it has been found that it is possible to irradiate a plant with microwave radiation, the radiation having an intensity, for a duration to heat the meristem of the plant to a degree sufficient to kill or stunt the growth of the plant. It has been found that heating the meristem of a plant of not less than 40° C. (and even higher, e.g., not less than 41° C. and even not less than 42° C.) for a relatively short time is sufficient for limiting the growth of the plant and even killing the plant.

In some embodiments, especially embodiments where the device is used to selectively irradiate a specific identified plant, the device further comprises a thermometer, preferably a non-contact thermometer.

In some such embodiments, for example, embodiments for manual use, the thermometer is configured to display the temperature detected to a user, for example, a pixelated thermal image displayed on a display screen allowing the user to determine when a specific plant has been irradiated to a sufficient degree to achieve a desired effect.

In some such embodiments, for example, embodiments for autonomous use, the thermometer is configured to provide the detected temperature to a controller which determines from the detected temperature when a specific plant has been irradiated to a sufficient degree to achieve a desired effect. Accordingly, in some embodiments, the thermometer is functionally associated with a controller configured (using software, firmware, hardware and combinations thereof) to identify the temperature of a plant, especially the temperature of the meristem of the plant. In some such embodiments, the controller is configured to control components of the device to irradiate or not irradiate a detected plant based on an identified temperature, e.g., to continue irradiating a plant which meristem has not been sufficiently heated and/or to stop irradiating a plant which meristem has been sufficiently heated.

For example, a device comprising slotted waveguide 54 depicted in FIG. 4 includes an infra-red imager 78 as a non-contact thermometer. Images acquired by infra-red imager 78 are provided to an associated controller which is configured to identify the meristem of a plant being irradiated using image analysis and to determine the temperature of the meristem.

### Safety Interlock

Microwaves are known to be potentially dangerous, for example to people. Accordingly, in some embodiments a device according to the teachings herein includes features that reduce the chance or prevent unsafe radiation of microwaves from the slotted waveguide.

In some embodiments, the device comprises a controller configured to receive input from some detector, to determine from the input the radiation-direction of the slotted waveguide and, if the radiation-direction is unsafe, prevent radiation of microwaves from the slotted waveguide. e.g., by preventing activation of the microwave generator and/or by ensuring that slot shutters are in a closed state.

In some embodiments, a detector is as described above is an orientation determiner which provides the controller with the orientation of a slotted waveguide and thereby the radiation-direction. For example, in some embodiments a device comprises a light detector as an orientation determiner. Suitable light detectors include one or more of a photocell, a digital camera, a thermal camera and a spectrometer. In some such embodiments, the light detector is attached to the device so as to have a field of view in the radiation-direction of the slotted waveguide and is further configured to provide characteristics of detected light as input to the controller. The controller is configured to receive the input and, if it is determined that the light detector is not oriented towards the ground (e.g., based on brightness, colors or wavelengths indicative of orientation towards the sky), the controller prevents radiation of microwaves from the slotted waveguide.

As noted above, in some embodiments a device comprises a non-contact range-finder. In some such embodiments, the range-finder is directed in the radiation-direction of the slotted waveguide and is configured to provide a determined range as input to the controller. The controller is configured to receive the input and, if it is determined that the range is greater than a certain threshold, e.g., greater than 30 cm, greater than 50 cm) it is presumed that the slotted waveguide and the radiation-direction are not oriented towards the ground and the controller prevents radiation of microwaves from the slotted waveguide.

In some embodiments, the device comprises a controller configured to receive input from a temperature detector, e.g., as described above, to determine from the input whether the temperature of a surface (such as a carpet, mattress or sheet) that is being irradiated has reached an unsafe temperature and, if yes, to deactivate the microwave generator and/or to activate an alarm. Such embodiments are useful to avoid overheating an item to the extent that the item is damaged or destroyed.

As noted above, in some embodiments a device comprises a physical offset-component. In some such embodiments, the physical offset-component includes a mechanism such as a microswitch that provides a first signal when not depressed and a different second signal when depressed, in some embodiments one of the two signals being a null (no signal). For use of the device (e.g., by activation of the microwave generator), the physical offset-component must be contacted with the ground to depress the microswitch which provides the second signal to the computer, allowing activation of the microwave generator and concomitant radiation of microwaves from the slot antenna slotted waveguide. When the physical offset-component is not in contact with the ground, the microswitch is no longer depressed, the first signal is provided to the controller which prevents emission of microwaves from the slotted waveguide by deactivation of the microwave generator.

### Supporting Structure

As noted above, a device includes a supporting structure for maintaining the slotted microwave waveguide in a position that is suitable for irradiating plants and/or an item potentially infested with arthropods during use of the device.

In preferred embodiments, the supporting structure is configured during use to maintain the side or face of the slotted waveguide from which the microwaves are radiated at a distance from plants and/or an item being irradiated so that the plants or item are in the near-field region of the antenna (e.g., not more than one wavelength from the slot antennas. e.g., 32.8 cm for 915 MHz microwaves and 12.2 cm for 2.45 GHz microwaves).

In some embodiments, the position suitable for irradiating plants is such that the vertical axis of the slotted waveguide is within 30° perpendicular to the ground during use of the device when the microwave generator is activated to generate microwaves. In preferred embodiments, the position suitable for irradiating plants is such that the vertical axis of the vertical axis of the slotted waveguide is within 25°, within 20°, within 15° and even within 10° perpendicular to the ground during use of the device.

### Supporting Structure for Portable Device

In some embodiments, as depicted in FIG. 1 with reference to device 10, a supporting structure 12 comprises a handle configured so that when a human user (i.e., a healthy adult human male of at least 170 cm tall and 65 kg weight) holds the handle, slotted microwave waveguide 20 is maintained in a position that is suitable for irradiating plants as recited above. In some such embodiments, a supporting structure further comprises additional components such as straps and/or a harness to help a user carry the device. In some such embodiments, the handle, microwave generator and slotted waveguide are together man-portable in terms of weight and dimensions. In some such embodiments, the power source for operating the microwave generator is a man-portable power source, e.g., one or more electrical batteries that are mounted on the handle. In some such embodiments, the power source for operating the microwave generator is a portable power source, e.g., one or more electrical batteries and/or electrical generators (e.g., internal combustion engine (ICE)) are man-portable and can be carried by a user (e.g., in a backpack), are portable and towed by a user (e.g., in a wagon) or in a motorized vehicle (e.g., an ATV).

In some embodiments, the device is configured to receive power from mains electricity via an electrical line, as discussed for device 10 depicted in FIG. 1.

### Immovable Supporting Structure for Emplaced Device

In some embodiments, the supporting structure is immovable and comprises fixed mounts that secure the device to a structure such as a building. In such embodiments, the slotted waveguide is typically mounted to direct radiated microwaves at a surface from which plants are expected to sprout or arthropods potentially gather, e.g., ant nests. In such embodiments, the power source for operating the microwave generator as well as other components of the device is any suitable power source. Since the device is fixed, in typical embodiments the power source is mains electricity via an electrical line.

In FIG. 8A is depicted an emplaced device 82 immovably fixed to a building 84 using a fixed mount 86 that constitutes a supporting structure.

In FIG. 8B is depicted an emplaced device 88 that is movably fixed to a building 84 using a fixed rail 90 that constitutes a supporting structure. Device 88 can drive along rail 90 with the help of an electric drive motor that is controlled by a controller that are components of device 88.

Both device 82 (which includes a slotted waveguide 20 substantially identical to that of device 10 depicted in FIG. 1) and device 88 (which includes a slotted waveguide 54 substantially identical to that depicted in FIG. 4) are mounted so that the bottom surface of the slotted waveguide is 5 cm from the ground. For use, devices 82 and 88 are periodically activated using a timer (e.g., by a controller, once every three days) for a duration sufficient to kill or stunt the growth of any plant that sprouts close to building and/or to eliminate ants that build a nest near the building. For device 82 which is immovably fixed in place, a duration of 10 seconds is typically sufficient. For device 88 which is movably along rail 90, the duration is related to the time it takes device 88 to ride along rail 90 to irradiate the ground along the entire length of building 84.

In some embodiments including an immovable supporting structure for an emplaced device, the supporting structure is further comprised for rotation of the slotted waveguide around an axis parallel to the longitudinal axis of the slotted waveguide. Such rotation allows irradiation of an area of a greater surface area. Typically the extent of such rotation is limited (e.g., so that the vertical axis of the slotted waveguide is never oriented at more than 30° from perpendicular to the ground) to prevent unwanted irradiation, e.g., of people.

### Supporting Structure for Mounting on a Vehicle

In some embodiments, the supporting structure is configured to secure the device to a vehicle, e.g., a motorized vehicle such as a tractor, truck, ATV, robot or a non-motorized vehicle such as a wagon. In some embodiments, the supporting structure is for fixedly mounting the device on a vehicle.

### Fixed Mounting to a Vehicle

In some embodiments, the supporting structure is for fixedly-mounting the device on a vehicle, preferably so that the slotted microwave waveguide is maintained in a position that is suitable for irradiating plants as recited above. For example, in device 68 depicted in FIG. 7A and device 72 depicted in FIG. 7B a support structure 12 comprises a bracket allowing fixedly securing device 68 to a vehicle such as a tractor. For example, in device 74 depicted in FIG. 7C a support structure 12 comprises a frame that fixedly secures device 74 to a towed or self-propelled vehicle. Such embodiments are exceptionally suitable for ensuring that planar open areas such as runways, playing fields, roads and streets are weed-free. For use, while the microwave generator 18 is operated, a vehicle is used to periodically drive back and forth along in open area in a pattern and at a speed to irradiate all portions of the surface of the open area for a period of time suitable to kill or stunt the growth of plants growing in the field. In embodiments where the vehicle is a robotic vehicle, this operation can be done autonomously.

In some related embodiments, the device comprises a slotted waveguide provided with slot shutters as described with reference to waveguide 64 depicted in FIG. 6. As the device is moved over a surface, a controller of the device analyzes images acquired from infrared imagers 78a-78f. When an undesired plant is identified by a specific infrared imager 78, the controller sets a corresponding slot shutter 66 to an open state, allowing selective irradiation of the undesired plant. Such an embodiment allows quicker treatment of an entire surface.

### Movable Mounting to a Vehicle

In some embodiments, a device according to the teachings herein the supporting structure is configured to allow movable mounting of the waveguide (and optionally, other components of the device) to a vehicle while the slot antennas are directed at the ground. Depending on the embodiment, a supporting structure is configured to allow any single motion or combination of motions that are useful for that embodiment.

In some embodiments the supporting structure is configured to allow movable mounting of the slotted waveguide that includes translation of the slotted waveguide parallel to the longitudinal axis thereof. In FIG. 9A, a device 92 secured to a vehicle 94 is depicted from above, including a slotted waveguide 20 and a supporting structure 12 that allows translation of slotted waveguide 20 in parallel to longitudinal axis 22 between a retracted and extended (depicted) position. Supporting structure 12 includes a rail 96 and an electric motor 98 operating a travelling nut screw mechanism. Some such embodiments are exceptionally useful for weed control around trees and along furrows or for arthropod control at wall/floor intersections: while slotted waveguide 20 is in a retracted position, vehicle 94 drives to a suitable position and then electrical motor 98 is activated to move slotted waveguide 20 to an extended position between two crop plants growing on a furrow or close to a tree to irradiate undesirable plants or close to a wall/floor intersection.

Alternately or additionally, in some embodiments the supporting structure is configured to allow movable mounting of the slotted waveguide that includes rotation of the slotted waveguide around an axis parallel to the longitudinal axis thereof. In FIG. 9B, a device 100 secured to a vehicle 94 is depicted from the side, including a slotted waveguide 20 and a supporting structure 12 that allows rotation of slotted waveguide 20 around an axis 102 parallel to longitudinal axis 22 so that a vertical axis 26 of slotted waveguide 20 can be moved ±30° relative to the ground. Some such embodiments are exceptionally useful for irradiating a undesired plant while the vehicle is moving as it allows microwaves to be directed at a certain location for a longer time by rotating the slotted waveguide as the vehicle moves forward. Some such embodiments allow scanning a relatively larger surface area by rotating the slotted waveguide.

Alternately or additionally, in some embodiments the supporting structure is configured to allow movable mounting of the slotted waveguide that includes motion (translation and/or rotation) of the slotted waveguide parallel to the ground. In FIG. 9C, a device 104 includes a slotted waveguide 20 and a supporting structure 12 that allows translation of slotted waveguide 20 in parallel to the ground along rail % and rotation of slotted waveguide 20 in parallel to the ground around axis 106.

Alternately or additionally, in some embodiments, the slotted waveguide is mounted on a robotic arm of the supporting structure, the robotic arm having at least two, at least three, at least four, at least five and even at least six degrees of freedom, as known in the art of robotic arms. In FIG. 9D, a device 108 includes a slotted waveguide 54 such as described with reference to FIG. 4 and includes an optical range finder with components 76, non-contact thermometer/camera 78 mounted on a robotic arm 110 having six degrees of freedom which is a component of a supporting structure 12. Such a device is preferably used in robot agriculture. The vehicle travels in a location (e.g., a field or green house) and uses camera 78 to identify, an undesired plant. Controller 16 then uses robotic arm 102 with reference to data received from the range finder and camera 78 to orient slotted waveguide 54 to effectively irradiate the plant. Irradiation is continued for a sufficient duration with reference to input received from non contact thermometer 78. An analogous device can also be configured to autonomously irradiate items such as beds, floors, curtains and the like for reducing the intensity of an arthropod infestation.

The power source for operating the microwave generator as well as other components of a vehicle-mounted device is any suitable power source. Since the device is mounted on a vehicle, in typical embodiments the power source is carried by the vehicle, e.g., one or more batteries and/or an electrical generator dedicated for operation of the device and/or a vehicular electrical generator.

### Experimental

### Device Design and Construction

A device according to the teachings herein as discussed above with reference to FIG. 1 was constructed and tested.

### Electric Field Characteristics of the Device

Using an electromagnetic field simulation code, the electric field characteristics of device 10 were studied.

In FIG. 10, the S11 of a single slot antenna 34 is shown, demonstrating that the design of the slot matches the operating frequency.

Since the intent was to irradiate plants with the near-field of the slot antenna (i.e., at a distance not more than one wavelength from the antennas 40), a near-field analysis of all six antennas 40 as arranged on bottom panel 34 of slotted waveguide 20 of device 10 was performed.

FIGS. 11A-11D show the normalized near-field patterns of slotted waveguide 20 in a plane parallel to bottom panel 34 at an offset distance of 5 cm (FIG. 11A), 3 cm (FIG. 11B), 2 cm (FIG. 11C) and 1 cm (FIG. 11D).

In FIGS. 12A and 12B are shown the absolute values of the intensity of the electric field in a plane parallel to bottom panel 34 at an offset distance of 5 cm (FIG. 12A) and 1 cm (FIG. 12B) in parallel to the longitudinal axis of slotted waveguide 20 from a proximal end (0 mm) to a distal end (500 mm) thereof.

From FIGS. 11 and 12, it is seen that at small offset distances from bottom panel 34 the electric field in a plane parallel to bottom panel 34 is mostly of low intensity with six localized high-intensity spots. In contrast, at a 5 cm offset distance, the electrical field defines a high-intensity contiguous region where all portions of the contiguous region have an intensity of ±20% of the average intensity of the region. Specifically, as seen in FIG. 12B, there is a contiguous region having an average intensity of ˜83 V/m where the highest intensities in the region are 90 V/m (8% above the average) and the lowest are 80 V/m (3.8% below the average). This high-intensity contiguous region is achieved by a combination of the physical dimensions of slot antennas 40 and the arrangement of slot antennas 40 on bottom panel 34 in two staggered rows and the distance of each slot antenna 40 from the centerline of bottom panel 34.

### Testing Efficacy of the Device

The efficacy of device 10 in limiting the growth of seedlings was tested and is described with reference to FIGS. 13A and 13B.

Two troughs 112 of 12 meters long, 50 cm wide and 20 cm high were constructed from wood planks and filled with coir substrate enriched with slow-release fertilizer. In each trough 112, cotton seeds were planted in two parallel rows separated by 30 cm, each seed 10 cm from a neighboring seed in a row, see FIG. 13A. An automated watering system was placed to ensure sufficient irrigation.

Each one of the two troughs 112 was divided into four types of sections: control, 2-leaf sections, 4-leaf sections and 6-8 leaf sections.

Seedlings in the control sections were not irradiated using device 10 and were observed to flourish and develop normally.

### Irradiation of 2-Leaf Seedlings

When the seedlings in the 2-leaf section were observed having two leaves (cotyledons), the seedlings were irradiated with microwaves using device 10. As depicted in FIG. 12B, the wheels of device 10 were placed on a flat wood rail 114 running parallel to the length of a trough. Bottom panel 34 was maintained at an offset distance of 4-6 cm from the surface of the coir and magnetron 18 was activated for a predetermined time. Since magnetron 18 produced 900 W of 2.45 GHz microwaves, each slot antenna 40 radiated a total of 150 W. Immediately before and immediately after irradiation, the temperature of the meristem of the seedling was measured using a Newtron TM-5007 digital thermometer (Extech Instruments, Waltham, Mass., USA) equipped with a thermocouple probe. Irradiated plants were monitored and compared to the control group. Results of the irradiation of the 2-leaf plants are summarized in Table 1 and in FIG. 14.

TABLE 1

| irradiation duration | 1 sec | ~3 sec | ~6 see |
|---|---|---|---|
| pre-irradiation temperature of | 30 | 30 | 30 |
| seedlings [° C.] | | | |
| average rise in temperature | 4.9 | 12.1 | 16.9 |
| [° C.] | | | |
| average final temperature of | 34.9 | 42.1 | 46.9 |
| all seedlings [° C.] | | | |
| final temperature distribution | 32-37.7 | 37-45 | 43-49.3 |
| [° C.] | (5.7) | (8) | (6.3) |
| seedlings killed [%] | 14 | 72 | 100 |
| seedlings survived [%] | 86 | 28 | 0 |

From Table 1 is seen that the final temperature reached is related to the duration of irradiation and increases at a rate of 2-7° C./sec (average ˜5° C./sec) and that seedlings which meristem reached ˜40° C. did not survive.

FIG. 14 shows the measurements of the increase in temperature for the different irradiation durations. Two data points (marked with arrows) were outliers, attributed to incorrect positioning of the waveguide relative to the respective seedlings.

### Irradiation of 4-Leaf Seedlings

When the seedlings in the 4-leaf section were observed to have 4 leaves, the seedlings were irradiated with microwaves using device 10. Since the seedlings were taller than in the 2-leaf stage, aiming of device 10 was more challenging. Two different methods were performed. The first method was positioning device over the seedlings and activating the magnetron, as described above. The second method included scanning the seedlings by moving slotted waveguide 20 back and forth in parallel to the surface of the coir. Results of the irradiation of the 4-leaf seedlings are summarized in Table 2 and FIG. 15:

TABLE 2

| irradiation duration | 2 sec | 5 sec | 9 sec |
|---|---|---|---|
| pre-irradiation temperature of | 25 | 25 | 25 |
| seedlings [° C.] | | | |
| average rise in temperature | 9 | 10.8 | 12.4 |
| [° C.] | | | |
| average final temperature of | 34 | 35.8 | 37.4 |
| all seedlings [° C.] | | | |
| final temperature distribution | 25-39 | 29-42 | 32-47 |
| [° C.] | (14) | (13) | (15) |
| seedlings killed [%] | 20 | 63 | 75 |
| seedlings survived [%] | 80 | 37 | 25 |

Comparing the results of Table 2 with those of Table 1, it is seen that the results and conclusions are substantially the same, but that it was more difficult to ensure that all seedlings were heated to the same sufficient degree due to the difference in heights of the plant. It is also seen that microwave irradiation according to the teachings herein is more effective at higher ambient temperatures, indicating that in some typical embodiments it is preferable to irradiate plants during the hotter portions of the day, e.g., (12:00-14:00).

FIG. 15 shows the measurements of the increase in temperature for the different irradiation durations and separating the measurements related to the static irradiation (upper solid line) and scanning irradiation (dashed lower line).

### Irradiation of 6 or 8-Leaf Seedlings

When the seedlings in the 6 or 8-leaf section were observed to have 6 or 8 leaves, the seedlings were irradiated with microwaves using device 10. Due to the size of the seedlings, there was no choice but to scan the device as described above. Results of the irradiation of the 6 to 8-leaf seedlings are summarized in Table 3:

TABLE 3

| irradiation duration | 2 sec | 5 sec | 7 sec | 12 sec |
|---|---|---|---|---|
| pre-irradiation temperature of | 26 | 26 | 26 | 26 |
| seedlings [° C.] | | | | |
| average rise in temperature | 17.5 | 15.7 | 16.3 | 13.7 |
| [° C.] | | | | |
| average final temperature of all | 43.5 | 41.7 | 42.3 | 39.7 |
| seedlings [° C.] | | | | |
| final temperature distribution | 37-52 | 33-50.7 | 40-47 | 35-43.8 |
| [° C.] | (15) | (17.7) | (7) | (8.8) |
| seedlings killed [%] | 37 | 18 | 56 | 100 |
| seedlings survived [%] | 63 | 82 | 44 | 0 |

From Table 3 is seen that longer irradiation times lead to a greater proportion of the seedlings being irradiated sufficiently to kill the seedlings, as is expected. An anomalous result is that the average rise in temperature was higher, the temperature distribution was greater and the highest temperature achieved was highest for the shorter irradiation durations. It is currently believed that the anomalous results are a consequence of the operator who actually moved the device back and forth over the plants. In the 12-second duration, there was sufficient time for the irradiation to be averaged to a relatively uniform degree. In the shorter irradiations, it was found that the operator often moved the device less as soon as he heard crackling sounds. Further, in such instances, the operator would measure the temperature at the single leaf that seemed most effected by the irradiation.

### Challenges in Measuring Plant Temperature

It is important to note that there were several reasons making it difficult to measure the plant temperatures accurately. There is a substantial and varying period of time required to move device 10 after the end of irradiation and to correctly place the thermocouple probe.

### Post-Irradiation Plant Growth

All the plants were allowed to continue growing after irradiation. It was clearly seen in all cases that the irradiated plants were weaker, less developed and less healthy than the plants in the control section that were not irradiated. For example. FIG. 16 is a reproduction of a photograph taken 1 week after treatment of the 4-leaf seedlings, on the left side the unirradiated control plants and on the left side the plants that were irradiated, for all three durations.

### Total Energy Required to Kill a Seedling

Calculations were made taking into account an estimated total surface area of the seedlings, irradiation duration and the electric flux from the antennas and it was found that about 10 J/cm² were required to completely kill 2-leaf seedlings while ˜25 J/cm² were required to completely kill the 6 to 8-leaf seedlings. This compares to the 40 J/cm² reported as being necessary in reference [4] by Velazquez-Martin et al.

Unless otherwise defined, all technical and scientific terms used herein have the same meaning as commonly understood by one of ordinary skill in the art to which the invention pertains. In case of conflict, the specification, including definitions, takes precedence. As used herein and in the priority document, the terms “antennas” and “antennas” are synonymous plural forms of “antenna”.

As used herein, the terms “comprising”, “including”, “having” and grammatical variants thereof are to be taken as specifying the stated features, integers, steps or components but do not preclude the addition of one or more additional features, integers, steps, components or groups thereof. As used herein, the indefinite articles “a” and “an” mean “at least one” or “one or more” unless the context clearly dictates otherwise.

As used herein, when a numerical value is preceded by the term “about”, the term “about” is intended to indicate +/−10%. As used herein, a phrase in the form “A and/or B” means a selection from the group consisting of (A), (B) or (A and B). As used herein, a phrase in the form “at least one of A, B and C” means a selection from the group consisting of (A), (B), (C), (A and B), (A and C), (B and C) or (A and B and C).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

For example, any device or slotted waveguide having any suitable cross section can have any suitable number of slot antennas, the slot antennas in any suitable arrangement, in one or more rows, colinear or not, staggered or not, with or without slot shutters on one, some or all of the slot antennas.

For example, any device can comprise and any slotted waveguide having any suitable cross section can be associated with any number of microwave generators, having any number and arrangement.

For example, any device can comprises or slotted waveguide having any suitable cross section can be associated with any suitable support structure, having any number and arrangement of slot antennas and having any suitable number of microwave generators.

For example, in some embodiments including two microwave generators physically associated with the same slotted waveguide, the two microwave generators are not necessarily alternately activated.

For example, a given device may include one or more slotted waveguides. None, one, two or more of the slotted waveguides are optionally identical. None, one, two or more of the slotted waveguides are optionally different. The arrangement of the slotted waveguides relative one to the other is any suitable arrangement.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1. A device suitable for irradiation of plants and/or for irradiation of items potentially-infested with arthropods with microwaves, the device comprising:
a. a microwave generator for generating microwaves having a specified frequency;
b. a slotted microwave waveguide, being a straight hollow conductor with a longitudinal axis, a vertical axis and a transverse axis physically associated with said microwave generator so that an aperture of said microwave generator introduces microwaves generated by said microwave generator into an inner volume of said waveguide, said waveguide including one or more slot antennas configured to radiate microwaves having said specified frequency generated by said microwave generator from said inner volume of said waveguide to outside said slotted waveguide all in the direction within 20° parallel to said vertical axis of said slotted waveguide; and
c. a supporting structure for maintaining said slotted microwave waveguide in a position suitable for irradiating plants and/or for irradiating items potentially infested with arthropods during use of the device,
wherein said one or more slot antennas are within 20° of parallel to said longitudinal axis and outside the plane defined by said vertical axis and said longitudinal axis of said waveguide.

2. The device of claim 1, said slotted microwave waveguide configured to be resonant with microwaves of said specified frequency.

3. The device of claim 2, said slotted microwave waveguide having two microwave-reflective longitudinal ends.

4. The device of claim 3, wherein said inner volume of said waveguide is dimensioned to allow constructive interference between microwaves reflected from said two longitudinal ends thereby allowing the device to reach a steady state where the amount of energy added by said microwave generator equals the amount of energy radiated from said slot antennas.

5. The device of claim 2, further comprising a second microwave generator for generating microwaves having the specified frequency, physically associated with a same said slotted microwave waveguide so that an aperture of said second microwave generator directs microwaves generated by said second microwave generator into said inner volume of said slotted waveguide.

6. The device of claim 5, wherein each one of said two microwave generators has a 50% duty cycle and the device is configured so that said two microwave generators are alternately operated so that microwaves are continuously radiated from said slot antennas.

7. The device of claim 1, said slotted microwave waveguide configured to be non-resonant with microwaves of said specified frequency.

8. The device of claim 7, said slotted microwave waveguide having two longitudinal ends:
a microwave-reflective longitudinal end on the side closer to where said aperture of said microwave generator introduces microwaves into said microwave waveguide; and
a microwave non-reflective longitudinal end.

9. The device of claim 7, wherein said slot antennas are at differing distances from said longitudinal axis of said waveguide, where slot antennas closer to said aperture are closer to said longitudinal axis than slot antennas further from said aperture.

10. The device of claim 7, said slot antennas positioned and dimensioned so that substantially all of the microwave energy that is introduced into said inner volume of said waveguide by said microwave generator is radiated by said slot antennas and does not exit through said non-reflective end of said waveguide and so that the amount of energy exiting from said non-reflective end of said waveguide is less than 10% of energy introduced into said inner volume of said waveguide by said microwave generator.

11. The device of claim 7, wherein a size of different said slot antennas and a distance of different said slot antennas from said longitudinal axis is such so that the amount of energy radiated from each one of said slot antennas is ±10% of the average energy radiated by said slot antennas.

12. The device of claim 1, said slotted waveguide including only one said slot antenna.

13. The device of claim 1, further comprising a controllable slot shutter functionally associated with a said slot antenna, said slot shutter having at least two states:
an open state during which microwaves can pass from said inner volume of said slotted waveguide through said slot antenna; and
a closed state during which microwaves cannot pass from said inner volume of said slotted waveguide through said slot antenna.

14. The device of claim 1, comprising two or more different said slotted microwave waveguides each with an associated magnetron generator.

15. A method for limiting the growth of plants, comprising:
providing a microwave generator with at least one functionally-associated antenna; and
irradiating a plant with microwave radiation from said at least one antenna generated by said microwave generator, said microwave radiation having an intensity for a duration to heat the meristem of said plant to a temperature sufficient to kill or stunt the growth of said plant.

16. The method of claim 15, wherein said irradiation is sufficient to raise the temperature of said meristem to not less than 40° C. and not more than 55° C.

17. The method of claim 15, wherein said irradiating comprises irradiating a surface, wherein said surface includes older plants and younger plants, said irradiating sufficient to substantially damage said younger plants without substantially damaging said older plants.

18. A method for reducing the intensity of an arthropod infestation, comprising:
providing a microwave generator with at least one functionally-associated antenna; and
irradiating an item potentially infested with arthropods with microwave radiation from said at least one antenna generated by said microwave generator, said microwave radiation having an intensity for a duration to heat arthropods to a temperature sufficient to kill at least some arthropods infesting said item.

19. The method of claim 18, wherein said item is animal manure.

20. The method of claim 18, wherein said irradiation is sufficient to raise the temperature of said arthropods infesting said item to not less than 40° C. and not more than 55° C.
